(19) United States
(12) Patent Application Publication
(10) Pub. No.: US 2014/0236663 A1
(43) Pub. Date: Aug. 21, 2014

(54) SYSTEM AND METHOD FOR PROVIDING UNIFIED WORKFLOWS INTEGRATING MULTIPLE COMPUTER NETWORK RESOURCES

(71) Applicants: TERRY SMITH, Toronto (CA); Alexander David Blom, Toronto (CA); Michael Vainberg, Maple (CA); Yannick Lallement, Toronto (CA); James L. Cloughley, Markham (CA); Cindy Gordon, Toronto (CA)

(72) Inventors: TERRY SMITH, Toronto (CA); Alexander David Blom, Toronto (CA); Michael Vainberg, Maple (CA); Yannick Lallement, Toronto (CA); James L. Cloughley, Markham (CA); Cindy Gordon, Toronto (CA)

(21) Appl. No.: 14/079,125

(22) Filed: Nov. 13, 2013

Related U.S. Application Data
(60) Provisional application No. 61/725,525, filed on Nov. 13, 2012.

(51) Int. Cl. G06Q 10/06

(52) U.S. Cl. CPC G06Q 10/0633
USPC 705/7.27

(57) ABSTRACT

A computer network implemented system is provided comprising a workflow designer that is operable to enable the design of one or more workflows that utilize information or functions from one or more (i) business systems, (ii) applications, or (iii) databases; and an application programming interface (API) that is configured to connect to the (i) business systems, (ii) applications or (iii) databases so as to monitor user actions, and based on such user interactions applying one or more workflow overlays that incorporate one or more intelligent features for enhancing functions of the business systems and the applications. A related computer implemented method is also provided. A computer network service is also provided that acquires information relevant to sales processes and processes the information to generate insights for improving sales performance. A sales forecasting utility is provided that applies data analysis operations to information elements relevant to a sales process. Insights may be presented to a sales representative on a real time or near real time basis so as to guide sales related activities.

### FIELD OF THE INVENTION

This invention relates to customer relationship management (CRM) systems and methods. This invention further relates to sales optimization.

### BACKGROUND OF THE INVENTION

Business and government entities often utilize in their operations a number of different applications, implemented using a plurality of computer network resources, linked to a variety of database technologies. For example, Company A may use an email application, a separate customer relationship management (CRM) system, a business management platform, a business intelligence platform, a document management system, a media content manager, and may also subscribe to one or more platforms for managing media content and managing social media campaigns (“business systems”). Typically, the business systems will emanate from a variety of different suppliers.

Company As personnel are typically organized into a plurality of groups responsible for different company functions. These groups will often need to access selected sub-combinations of the features of one or more of the business systems in support of specific workflows in which they the features. These user groups may engage in one or more workflows regularly, and these workflows may require, using traditional approaches, accessing two or more business systems. For example, sales related workflows are similar in many organizations. A typical sales workflow may include (1) lead research, (2) lead discovery, (3) a lead “touch point” or connection, (4) logging the lead to a sales system, (5) entering the lead details, (6) initiation of a sales workflow (for example using one or more sales automation tools) to advance a lead for example toward a sale (“sales workflow”).

There also may be a number of related workflows such as aggregating leads and analyzing aggregated information to enable activity tracking, sales pipeline analysis, reporting on sales pipelines and so on.

Sales personnel in engaging in the sales workflow typically need to use more than one business system to perform the basic functions involved in their sales activities, and this can result in duplication, for example of data entry. Also, while prior art systems used to support sales workflows provide benefits to the company, sometimes these benefits are weighted heavily towards managers, whereas in order to support related system functions, sales personnel often need to engage in time consuming administrative tasks that may not be their strength and that divert time from more meaningful sales oriented tasks such as meeting with potential customers. There is a natural tendency of sales personnel to neglect these time consuming administrative duties which can have a negative impact on the utility of the relevant business systems such as sales automation platforms.

Execution of the sales workflow often requires the use of multiple business systems in ways that may be less than intuitive. Sales personnel may need to routinely utilize a specific subset of two or more technology resources, but these resources may be difficult to find amidst other non-core features of relevant computer programs. This may add to technology training costs. And some talented sales personnel may not be particularly technology savvy. Even for those sales personnel who are familiar with the business systems used in connection with the sales workflow, non-relevant business system features may be distracting, and the use of business systems based on a design that is not customized for the sales workflow may require a greater than optimal number of steps on the part of the sales personnel, thus decreasing productivity.

Various user groups, including for example sales personnel, would benefit from simplified workflows that integrate functions or features from two or more business systems, presented in a way that is intuitive to the users, and that provides the “right” amount of functionality to the users. Business systems do not typically permit a significant amount of customization of workflow or presentation of the workflow steps through UI for example. If customization is permitted, then usually this requires cooperation of the vendor and the associated costs may be significant. This problem becomes a more significant challenge where a given workflow, that is desirable from a user and company perspective, requires the use of functions or features of multiple business systems. Particularly if the business systems are from different vendors, and even more so if the business systems emanate from competitors, integration of the business systems may be difficult and costly, or in fact in some cases impossible.

In addition, given the variety of different workflows that may be required by the various user groups, based for example on their recurring technology dependent activities, the cost of integration may be prohibitive in enabling all or a substantial number of the desired workflows using prior art technologies and methods, especially where there are significant integration requirements.

Additionally, in many organizations, there is a need to continuously improve workflows, for example to keep up to date given changing requirements, to streamline workflows, to refocus processes based on insights accumulated over time, and so on, Because of the challenges identified above, this type of incremental improvement can be cost and time prohibitive, and as a result, organizations miss opportunities for operational streamlining or optimization of organizational resources. This can result in companies failing to meet their objectives such as sales objectives.

Moreover, execution of company directed aspects of the sales workflows often requires access to specific technology resources, and these may not be readily accessible when most convenient to the sales personnel, for example when they are in the field between customer meetings and they may have access to a mobile device but not to a laptop and Internet connection that may be required for certain business systems.

Certainly, suppliers of business systems often make mobile applications available to interact with their enterprise systems but these applications generally do not enable the selective access of features or functions from two or more business systems, which may be desirable from the perspective of providing an efficient and user friendly workflow to users.

Various CRM systems and methods are known, which enable sales professionals to engage in a series of activities such as tracking contacts, and managing sales activities, including “sales funnels”.

Sales funnels are often more than 30-40% inaccurate, and 35-50% of sales professionals also do not meet their sales plans. Current CRM platforms generally include high level sales funnel related functionality but do not provide insights that are actionable by a sales/marketing professional such as for example analysis of interactions with a prospect or customer, so as to generate an objective analysis of the probability of closing on an opportunity (based on indicators such as interactions with the target, and analysis of parameters of such interactions), or suggestions based on such analysis.

CRM systems and method, and other sales and marketing automation solutions, provide relatively workable mechanisms for structuring the sales funnel (from leads to prospects to customers) and capturing transactional data along the way. Conventional solutions however do not provide a mechanism for transforming such transactional data into insights.

There is a need therefore for a computer network implemented system, a computer network implemented method, and a computer network architecture that addresses the challenges referred to above. There is a further need for a computer network implemented system, a computer network implemented method, and a computer network architecture that addresses the challenges referred to above and that is easy to deploy, and flexible enough to support efficient design, implementation, and updating of multiple workflows, including workflows that may rely on multiple business systems. There is a still further need for such a computer network implemented system, a computer network implemented method, and a computer network architecture that addresses the needs of the mobile workforce, and further that enables flexible use of cloud computing technology resources, thereby providing improved scalability.

There is also a need for systems and methods for generating insights relevant to sales funnels.

### SUMMARY OF THE INVENTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect of the invention, a computer network implemented system is provided comprising: one or more server computers, linked to a web application or application respository, or to a cloud service, providing: (a) a workflow designer that is operable to enable the design of one or more workflows that utilize information or functions from one or more (i) business systems, (ii) applications, or (iii) databases; and (b) an application programming interface (API) that is configured to connect to the (i) business systems, (ii) applications or (iii) databases so as to monitor user actions, and based on such user interactions applying one or more workflow overlays that incorporate one or more intelligent features for enhancing functions of the business systems and the applications.

In another aspect, a computer system is provided comprising: at least one client computing device; and at least one computer server in communication with the at least one computing device over a communications network; the at least one client computing device configured to: receive one or more sales process parameters; analyze information elements from one or more data sources or data stores, based on the sales process parameters so as to generate one or more insights relevant to performance of a sales representative relative to one or more sales objectives; and presenting the insights to a sales representative to guide one or more actions of the sales representative.

In another aspect, the computer system includes an insight engine that implement one or more data analysis operations.

In another aspect, the computer system when executed provides intelligent insights for meeting sales objectives (such as sales forecasts) on a real time or near real time basis so as to guide a sales representative in sales related activities.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 depicts an exemplary system diagram illustrating the network architecture for implementing the present invention, in accordance with one embodiment of the present invention.

FIG. 2 is a system diagram that illustrates certain functions of the workflow management system of the present invention, in a particular embodiment thereof.

FIG. 3a is a further system diagram illustrating a representative implementation of the network architecture of the present invention.

FIG. 3b illustrates in greater detail a representative implementation of the network architecture of the present invention.

FIGS. 4a, 4b, 4c, 4d, and 4e illustrate representative interfaces for implementing the system of the present invention, and more particularly the integration of marketing automation related processes into use of an email application, using the system and method of the present invention.

FIGS. 5a, 5b, 5c, and 5d illustrate an alternate embodiment of the invention, in which marketing automation processes are provided using a web portal enabled by the present invention.

FIGS. 6a and 6b illustrate representative mobile application screens that show the mobile access to data and functionality enabled by operation of the system of the present invention.

FIG. 7 depicts the entire process from data acquisition through to the production of insights that are then used to share, alert and prompt the user to take action.

FIG. 8 depicts the process of identifying classifiers at Stage n in a sales process derived from facts acquired from external data sources and using those classifiers to derive insights.

FIG. 9 depicts the data acquisition model and method of taking data from external sources and building facts based on them.

FIG. 10 illustrates a generic computer implementation of the computer program aspects of the present invention.

### DETAILED DESCRIPTION

The present invention provides a computer network implemented system, a computer network implemented method, and a computer network architecture that enable one or more unified data workflows and related processes based on integration of a workflow management system (2) with one or more business systems in a way that enables one or more user workflows and related processes that may rely on a plurality of underlying local applications and/or company databases.

It should be understood that in the present disclosure a user workflow refers to a collection of computer implemented processes, involving one or more data elements that produce one or more outcomes. One example of a workflow, as this term is used in this disclosure, is a sales management workflow. As explained above, sales related workflows including sales management workflow may involve multiple business systems. The present invention enables the definition of one or more unified sales management workflows that enable users to engage in their work, via one or more computers, supported by multiple system resources (whether cloud based resources, enterprise computer or application resources, client computers or application, or mobile devices or mobile applications). The present invention is operable to enable the design and implementation of workflows that are of cross-platform, cross-system, and/or cross-application in a flexible, simple, and cost effective way. For example, the present invention may enable the insertion of added features that operate within or along the side of applications that are familiar to users, or the presentation of unified interfaces that in the background seamlessly integrate functions and data from multiple sources.

The present invention provides significantly variability and flexibility in the collections of features and data sources that may be assembled in furtherance of particular business objectives. All of the web objects (may be implemented as web pages) enabled by the web application (10) of the present invention that may, with little user intervention, be configured to includes one or more notifications, for example from specific business systems that related to a workflow embodied in a particular web object. For example, in a sales related workflow current information that may come up in conversation can be made readily available by incorporating in sales related web objects of information regarding manufacturing status, delivery status for a recent order, outstanding accounts receivable and so on.

The web objects may be implemented in the system of the present invention as widgets inserted in web pages presented by the web application (10), and these widgets may be linked to business systems (4). For example, records from an existing CRM may be selectively present in conjunction with associated information in a web page presented by the web application (10) using a widget configured to extract and present information from the CRM.

It should be understood that the sales management example is but one possible implementation of the technology of the present invention. Numerous other applications are possible, and some of these are described below. Generally speaking, the present invention provides significant advantages where there is a desire to deploy, and adjust from time to time (for example based on changing conditions) a series of workflows in furtherance of one or more business objectives, especially where these workflows may rely on information or functionality from multiple sources that may be complicated or time consuming to integrate.

In one aspect of the invention, a novel and innovative distributed computer and database architecture is provided that enables the design and deployment of multiple user workflows in an efficient manner, in connection with existing computer systems, computer applications, database infrastructures, and/or external data sources (4) that may be difficult to integrate with or otherwise interoperate with. The present invention is based on a novel and innovative overall approach to deploying user workflow functionality that instead of customization of, or integration into, existing computer systems, computer applications, database infrastructures, and/or external data sources (“existing business systems” or “business systems”), utilizes a novel and innovative distributed architecture (that may include cloud computing based resources) that is operable to apply intelligently one or more of a series of strategies for integrating one or more functions of existing business systems into one or more user workflow overlays applied by the workflow management system.

It should be understood that the business systems may also include remote, third party data sources such as for example LinkedIn™. Twitter™ and others, wherein a workflow implemented by operation of the present invention may include a step of automatically retrieving relevant information from such external sources upon for example a user completing an associated workflow step.

In one aspect of the invention, the workflow management system (2) includes a user workflow designer (6) and an automated data flow manager (8). The user workflow designer (6) may be implemented as a series of functions of a web application (10). For example, a business or government entity (the “entity”) may define a series of user workflow objectives, related for example to a business process used regularly by the personnel of the entity or for example a selected group of the personnel. The workflow designer (6) provides a series of tools that enable one or more administrative users to design a new workflow (11), for example by modifying an existing workflow template stored to the database (12). Workflow (11) may include a plurality of steps or processes, and each step or process may rely on one or more business systems (4). The workflow designer (6) may also enable the administrative user(s) to define the interface to be presented in connection with the steps, so as to enable the compilation of a custom interface for an underlying application, or in fact the workflow designer (6) may incorporate or be linked to an application development platform such that selection of specific steps or attributes associated with steps, may define parameters for one or more local applications (14) for implementing the workflow (11), for example based on the features accessed using the application development platform. It should be understood that “local applications” references existing applications used in an enterprise, one or more of which are linked to the system of the present invention. The local applications may be a server application, desktop application, tablet application, or mobile application.

The user workflow designer (6) may also be understood as a custom form builder that enables the design and compilation of custom forms, such as for example a form embodying required sales steps in sequence, and associated with such steps required data entry items and associated processes that may be supported by functions or data associated with local applications or databases, integrated into the use of the form by operation of the distributed architecture of the present invention. The custom form may be used by a sales person for example using a local application (14), configured to interoperate with the API (16). The programming embodied in the custom form, or the custom form loaded on the local application (14) may initiate a variety of processes which may include one or more automation steps. Significantly, these automation steps, relying on the API (16) as a bridge to local applications, can leverage functions and features, and associated databases, linked to the business systems (4) including for example local applications, but also external data sources for example. This enables the dynamic configuration and reconfiguration of workflow functionality, in support of a range of activities including but not limited to sales activities, that integrate best available functionality and data at the relevant time. From a user perspective, the system of the present invention is operable to enable one or more workflow related applications. These may be implemented as custom applications, new features integrated into local applications (14), or custom screens that overlay local applications (14) (collectively referred to as “workflow feature objects”).

The workflow feature objects (13) can be understood as system, application or data processing features that are triggered based on one or more user actions by operation of a logger (15) that is operable to monitor user actions in one or more local applications (14), systems, or databases mapped to the logger (15), such that based on operation of the automated data flow manager (8), one or more of the user actions may be recognized as triggering one or more aspects of the one or more workflows defined by the automated data flow manager. For example, an email received or sent to a contact appearing in a sales lead list may automatically trigger presentation of a form within the email application or a pop up screen or as an overlay to the email application a form requesting a status for the lead. Other examples are provided below.

The workflow feature objects (13) may be implemented as a custom application or custom screen that implements the workflow (11), and may be perceived for example as a part of an existing business system, a plug-in to an existing system, or a special purpose computer program. Meanwhile, the workflow feature objects (13) may by operation of the system of the invention leverage dynamically the resources of multiple business systems so as to provide workflow functionality across the multiple business systems (4), in other words providing a “unified workflow”. This unified workflow functionality is enabled by the innovative distributed architecture described in this disclosure that enables the integration of disparate business systems in an easy to implement and flexible way.

It should be understood that the workflow designer (6) enables the mapping of the links between the workflow (11) and one or more business systems (4).

The automated data flow manager (8) uses the distributed architecture of the present system to ensure that business system functions or data accessible via business systems, is accessible to the custom application (14) regardless of the particular business system involved.

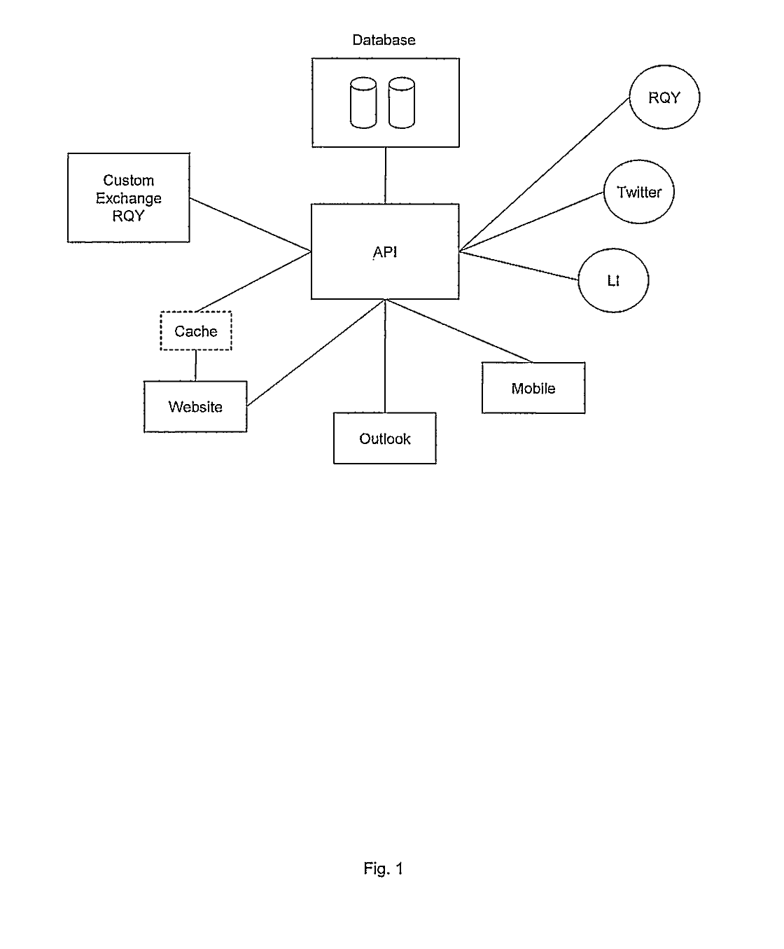

As shown in FIG. 1, the present invention includes a middle layer or Application Programming Interface (“API”) (16) that is operable to dynamically integrate one or more local applications (14) with one or more associated business systems (4), based on the requirements of the workflow (11). The middle layer (16) may be implemented as a cloud based utility that implements the automated data flow manager (8). The data flow manager (8) is operable to connect to the relevant business systems (4) using the API in effect to achieve database level synchronization between the database (12) that is linked to the API (16) and the business systems (4) such as local application such as for example email applications and the like. This mechanism allows the extraction or scraping of selected data from business systems (4) such as local applications that support one or more steps or functions of workflow (11).

The API (16) includes programming (such as local application specific APIs for example) so as to enable interoperation with a variety of business systems (4). The API (16) may be linked with one or more web platforms or web services for automatically updating application specific APIs if these are changed by applicable vendors. The data flow manager (8) is operable to automatically establish data connectors or links to for example local applications by locating associated databases, and relying on the API (16) establishing such data connectors or links directly into such associated databases. This enables the data flow manager (8), based on relevant workflows (11) to track the creation or modification of relevant data elements (data, files, documents etc.) stored to the associated database, and automatically replicate these data elements and store them in the database (12) by operation of the API (16) (“stored data elements”).

The stored data elements may be logged and time stamped by operation of the data flow manager (8).

These stored data elements may be made available to a web portal (18). The web portal (18) may be understood as a server application that implements the automated data flow manager (8) and that may interoperate with the various local applications (14) to enable the relevant workflows. In effect the system of the present invention, in one aspect enables the synchronization of the web portal (18) with the business systems (4), including local applications, at the database level. The web portal (18) enables the execution of one or more workflows using one or more local applications (14) that are configured to interoperate with the web portal (18) via the API (16), and in effect leverage the functions and resources of the business system (4) based on operations enabled by the web portal (18) and a database originating from databases linked to the local applications, without the need to access the local applications or the databases directly. In other words, the API (16) and the associated utilities (such as the web portal (18) in particular) provide a functional overlay with which workflow feature objects (13) can interoperate to, in effect, access functions and features of the business systems (4) for example local applications of an enterprise environment, without the need to interface with the business systems themselves.

The API (16) includes middleware that is operable to translate data elements obtained from the business systems (4) or associated databases, for example into a common format. A variety of local applications (14) may be configured to obtain the translated data elements that may originate from a variety of formats, and yet are available for processing in the common format, by operation of the distributed architecture of the present invention. The data flow manager (8) in effect is operable to automatically catalogue workflow (11) associated data elements, and store these to a database (12) linked to the web portal (18) so as to make the data elements available dynamically to workflow (11) related processes on an as needed basis, once the data elements are requested by an authorized local application (14) recognized by the API (16).

This particular aspect enables the design and implementation of workflows (11) that involve a wide variety of business systems (4) without difficulty in integrating into or interfacing with a particular business system (4) acting as a barrier. This approach allows desired function to be the principal design prerogative for workflows (11) and local applications (14) that implement them.

In an example of the use of the “custom forms” functionality, based on a client's needs, the workflow designer enables the creation of one or more forms with fields corresponding to each sales stage, along with associated requirements such as entry of specific client information, signature by specific individuals of specific documents, and so on.

The web application (10) of the present invention, in effect enables the configuration of an environment that is similar to an application development environment without the added costs that use of such an environment ordinarily entails. Also, while application development environments may permit the new workflows to be designed and implemented on top of functionality that is built into the environment, generally speaking incorporation of features or functions of third party system is not possible, or is difficult.

The present invention provides a novel and innovative way of overcoming these limitations.

Also, the business or technology environment that produces the need for adoption of new workflows or updates to existing workflows can be very fluid. For example, in a sales environment new insights are developed all the time regarding workflows that are effective in driving sales. Similarly, the sales environment is fluid and therefore the desired best practices for sales personnel are subject to change. Also, sales techniques need to reflect that what works for one sales person may not work for another. The changing composition of sales staff and because of this the evolving cultural, demographic, social, and personality traits of the sales staff as a whole, also requires adjustment of sales strategies and how these are applied in specific instances. All of these factors are examples of what contributes to a changing environment. To develop and update workflows that keep up with these changes is often impractical. The present invention solves this significant problem.

Performance Optimization

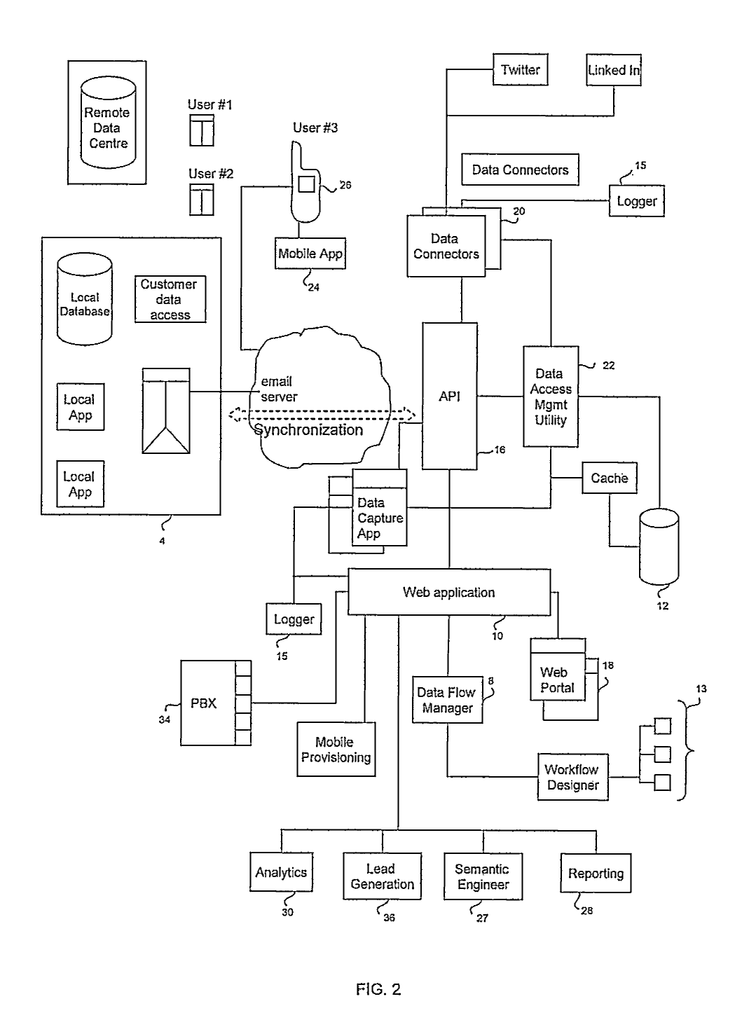

In one aspect of the invention, as best shown in FIG. 2, a cache memory utility (24) may be linked both to the API (16) and also optionally to the web portal (10). The API (16), based on the workflow (11), and based on the data flow manager (8) inferring from successive calls to the API (16), as determined by the call logs, is operable to pre-fetch or dynamically retrieve selected stored data elements from the database (12) or alternatively from associated database linked to for example local applications. The pre-fetched data elements may be stored using the cache memory utility (24) and retrieved from there by the API (16) in response to associated calls from the local application (14) based on the workflow. In effect the API (16) enables access to selected features of the web portal (10), and the web portal in turn is operable to provide access to from the cache (24) (in read only form only) and/or database (12). In one aspect of the invention, the data flow manager (8) is operable to ensure that the cache (24) is read first to find relevant information, and if it is not available there then a call is made to the database (12).

The cache (24) may be implemented so that each information object, such as a contact, is implemented as a record, with sub-records. For example, name, email address, social media feeds and other information may be tagged separately, being separate sub-records. This enables the mapping of information on a sub-record to sub-record basis into possibly distinct data sources, for example particular databases or business systems (4). The cache (24) in one aspect of the invention is implemented such that records are flagged based on the likelihood that users of the system may require regular access to the relevant information of sub-records. The system of the invention is operable to pre-fetch information, and populate records in the cache, so as to enable faster access to relevant information for the workflows enabled by the present invention. The system may be operable to check the cache (24) to see if information required in support of a workflow (11) is available in the cache (24), and if it is not, then retrieve the information by operation of the data access management utility (22) and the links to business systems (4), or the data connectors (20) linking to external data sources.

A skilled reader will understand that the cache (34) is optional. Other arrangements are possible for providing access to the data elements. For example, as explained below, the computer system may include intelligent filtering features such that relevant information is filtered and only relevant information is stored to the database in order to provide rapid access in support of platform functions.

Security

It should be understood that the API (16) also fulfills a security role in the distributed architecture of the present invention. Any local application (14) can access the database (12) through the API (16), and therefore one of the functions of the API (16) is to act as a security layer as between the database (12) and associated local applications (14) there by maintaining the security and confidentiality of the data elements obtained from the local applications.

In another aspect of the invention, the API (16) is operable to define a shared, cloud implemented data resource where, however, access is managed by an access management utility (22). The access management utility (22) is operable to enforce hierarchical permission such that (A) only authorized local applications (14) are operable to connect through the API (16), and (B) authorized local applications (14) are only operable to connect to specific resources for which they are authorized, e.g. particular database records or areas.

In one particular implementation of the present invention, the API (16) may be configured so as to abstract the database (12) and therefore local applications (14) do not access the production database. In addition, calls to API (16) are authenticated by the access management utility (22) and signed, on a per user basis. When a user logs into the API (16), by means of the access data management utility (22), and from their local application (14), the local application (14) is sent a public and private key. The public key is sent along with every request and the private key is used to sign the request. This allows the operator of the system to revoke a user's access or change their public/private key pair at any time and they will be forced to re-login and get a new key pair (if the operator of the system gives them one). It also means that the access data management utility (22) is operable to track activities through a log including a time stamp and based on this generate for example a per user log of all calls made against the API (16). For example, if the workflow (11) requires the upload of a file from a local application (14) to a plurality of business system (4) end points, the local application (14) will be required to provide its public key, a time stamp for the request, a signature and any other parameters that may be associated with the upload, such as for example file data type, file name, file size, etc.). API (16) may include a security layer, such as an SSL, to enable secure communications as between the API (16) and data points including those configured for the local applications.

It should be understood that the present invention enables the interoperation with one or more hardware or software components located behind a firewall.

Possible Intelligent Features

The computer system of the present invention may be configured to implement various intelligent features. These intelligent features may utilize the analytics engine (30). Examples of such intelligent features are provided below.

(A) The computer system may enable translation of data elements from a plurality of data sources into a series of tags that may be utilized to provide context to various system workflows without the need to continuously interface with the data sources themselves.

(B) Automatically analyzing target specific data sources, or data sources relevant to a group of individuals sharing common attributes, so as to optimize one or more workflows based on automatically extracting behavioural information for selected targets. For example, the platform may be operable to identify the best time of day, or day of week, for sending an email to, or to phone, a particular sales prospect, for example because a sales prospect may be more likely to be online or available by phone at certain periods of time.

(C) Similarly, online interactions or email communications with a sales prospect may be analyzed to determine various parameters that may be relevant to targeting a sales prospect in an effective manner. For example the computer system may determine the best mode of communication with a prospective target customer or customer perhaps by analyzing bursts of activity or inactivity.

(D) The computer system may determine for example the current mood of a sales prospect, for example by applying sentiment analysis to postings of a sales prospect captured from their social media feeds.

(E) The computer system may develop over time a personality file, demographic profile, or psychographic profile for a sales prospect, which may be used by the computer system in various workflows. The computer system may utilize for example learned, observed, and/or evaluated personality traits.

(F) The computer system may utilize the various intelligent features described above for example to dynamically suggest targeting strategies which may for example, based on the present invention, be integrated with various existing applications or business systems. For example, the computer system may trigger reminders at the relevant time to contact particular sales prospects who may be more open to marketing messages at that time. A system generated notification may also for example suggest a specific product or service that a prospect is most likely to be interested in, including at a particular time. The computer system may also for example iteratively match a sales prospect with a particular sales agent to exploit for example a personality match. A variety of different user interfaces may be used to present this information, such as for example “hot buttons”.

(G) The computer system may analyze various available data sources. For example, the computer system may link to one or more social media platforms in order to extract information concerning users who have “LIKED” particular products, content, or services, but also the content associated with the social media interactions of a target, to provide deeper analysis of the preferences or interests of a target.

(H) Also, the computer system may automatically crawl email accounts for relevant information and initiate one or more automated processes. For example the computer system may automatically search a user's email for email addresses that are not yet entered to a contact database, and automatically create a contact entry; and optionally remind the user from time to time to add further information to new contact entries created in this way.

(I) The analytics engine (30) may also apply one or more operations for generating insights based on extracted information. These may include semantic operations (for example analysis of an article that a target has read), weighting of content, fuzzy logic operations, artificial intelligence, and so on. Also, the platform may enable: site behavior profiling (e.g. click path analysis, purchase patterns analysis); collaborative filtering (“people who have behaved like you were more likely to perform some specified activity”); and keyword search of content.

In one aspect of the invention, the platform (A) extracts information from a sales target's email traffic for example, that may be exchanged between a sales agent and the sales target. This information may be (B) linked for example to a CRM system so as to enrich sales workflow for example by integrating the analysis data resulting from the intelligent operations described. Finally, data for an organization may be (C) may be matched with other data such as phone records to automatically aggregate information to generate new insights.

The resulting automatically generated information may also be matched with information from other associated sales tools such as sales records, notes, opportunity stages.

The overall platform architecture and associated resources enable these new and innovative processes.

The computer system may utilize data sources to calculate a probability score for closing on a sales opportunity for example. The computer system may also automatically update this score, reflecting for example factors that may jeopardize a sales opportunity, or conversely the computer system may inform a sales agent when a sales opportunity is progressing well. In one aspect, the computer system may calculate a sales opportunity progress value or rating to enable the monitoring of sales opportunities and management of multiple sales opportunities, including completion of associated tasks.

The resulting data set enables highly accurate sales predictions that are not possible in prior art solutions. Rather than operating on instinct, sales personnel may rely on validated information to improve sales initiatives and take advantage of opportunities; and this information may be extracted dynamically from various different platforms, databases, or applications, without the need to conduct all related activities for example on a single platform, or the need to invest in costly integration. The data may be mapped to outcomes, which then provides additional data sets for analysis in order for example to extract best practices.

In another possible implementation, the cache (24) may be configured to only retain selected information that is deemed to be of sufficient importance or meet configurable relevance thresholds The analysis data referred to above may be used to selectively store information to the cache (24) and to discard the remaining information from the cache (24).

Further Details of Implementation

In one aspect of the implementation of the invention, the API (16) and associated database (12) may be implemented in the cloud. Users may be associated with any manner of client device (20) that may access the API (16) via the Internet including for example smart phones, desktop computers accessing the system via a standard web browser, mobile tablets, televisions, laptops and desktops, etc. All client devices are operable to communicate with the API (16) via standard web protocols (http, https) by means of the cloud.

A cloud based implementation of the present invention may be hosted in two parts: a production web site and a working backup server to which traffic may be redirected in the event of a service failure. The production site may be based, for example, on Amazon Web Services Elastic Compute Cloud and Simple Storage System, while the working backup server may be implemented using dedicated servers.

Database (12) may be implemented so as to replicate data elements in real-time using MySQL's built-in replication system from the production site to the working backup server.

The working backup server may include so include a copy of the API (16), the web portal (10), the data connectors and even relevant local applications. When files are uploaded to the API (16) and entered into the database (12), these files may also be uploaded to Amazon's Simple Storage System (S3) and replicated to the working backup server associated with the platform of the present invention as well.

The API (16) may be written in PHP and may connect directly to a MySQL database on the back-end. For optimization, the API (16) may also include an object cache; for example, when a request is made to look up a contact with ID 123, the system may look up the contact in the cache (24) first, before checking the database (12).

The web portal (10) may be understood as the data front-end of the system of the present invention. The web portal (10) may be configured to connect to the API (16) to perform all actions. For optimization, the web portal (10) may share the same object cache with the API (16) and may check the object cache first before making unnecessary API calls. The web portal (10) may be used for example as the mechanism for users to perform actions initiated by the local application (14) such as for example creating and modifying contacts, opportunities, announcements, and actions, as well as uploading documents and creating custom reports.

The web portal (10) may enable for example a variety of custom forms as described above, which may include enhancement such as auto-completion or auto-suggestion features, across multiple local applications for example, which would be very difficult to implement using prior art technologies.

The system of the invention may enable the extraction of information from a wide variety of business systems (4) and especially local applications. Local applications may connect to and synchronize with the API (16) much in the same way that the web portal (10) does. Examples of implementations of the links to local applications include an OUTLOOK™ side bar or a Google Apps™ integration. These permit for example the automated retrieval of a user's actions, task, new contacts and so on, and thereby for example if a sales employee selects in his/her local application (14) a contact or email, then the local application is initiated by the data flow manager (8) to check with the API (16) see if the sender is a contact/opportunity in the system, and relevant information is retrieved and displayed through the web portal (10).

Examples of data connectors are data connectors configured for Exchange™ or Google Apps. For example, these data connector enable connection from the cloud infrastructure of the present system to the associated email server, and obtain message headers. These may be checked against the client's known contact list, and any messages that need to be recorded for contacts in the system are downloaded, including any attachments. These data connectors download and queue messages and attachments to be logged, and they are then sent in the order they are downloaded to the API to be entered into the database.

It should be understood that the workflows that may be enabled by the present invention can be triggered by user initiation, or for example an external event such as a change in an associated data source. For example, in an implementation of the present invention as a sales automation system, the system is operable to automatically create an opportunity, to track progress of actions on opportunities.

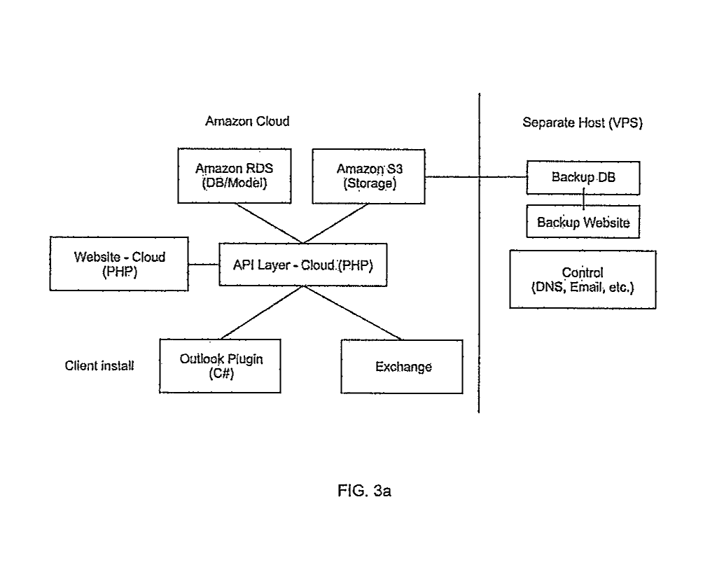

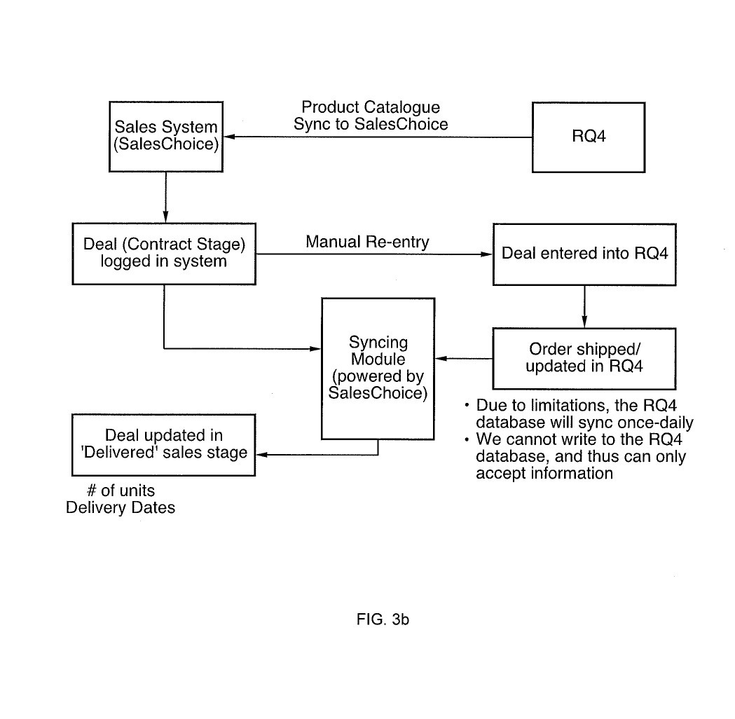

FIG. 3a is a further system diagram illustrating a representative implementation of the network architecture of the present invention.

Regarding the architecture enabled by the present invention, the following possible features of the present invention are noted:

The API enables data points and local applications to connect to central cloud servers. The API enables data points to synchronize with local applications through the cloud architecture of the present invention. The API is configured to enable a uniform yet tight integration of potentially multiple local applications as well as for example associated databases. It should be understood that “local applications” include for example enterprise or local applications, but also web enabled applications such as GOOGLE apps. The API (16) implements one or more security features. For example the API (16) is operable to enable SSL secure connections for all data points or local applications linked to the API (16). In one aspect of the invention, the API (16) is operable to obtain data from linked applications and/or databases based on a pull architecture.

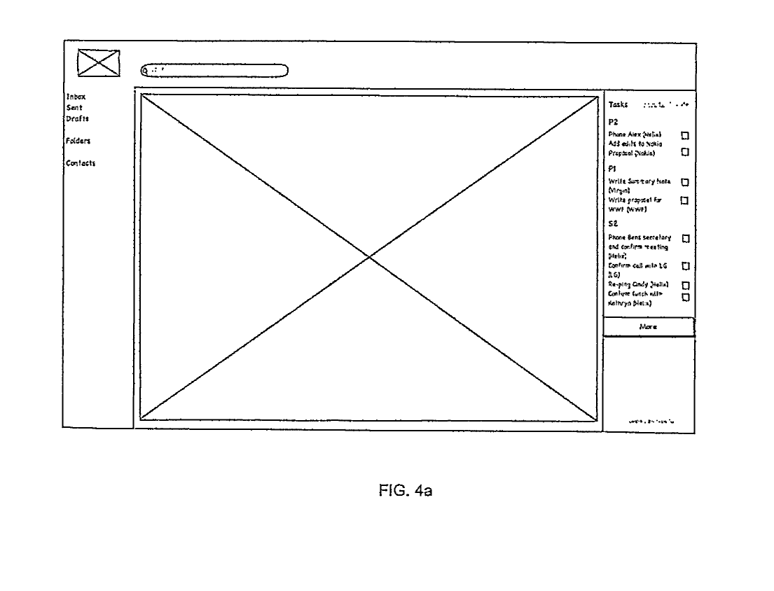

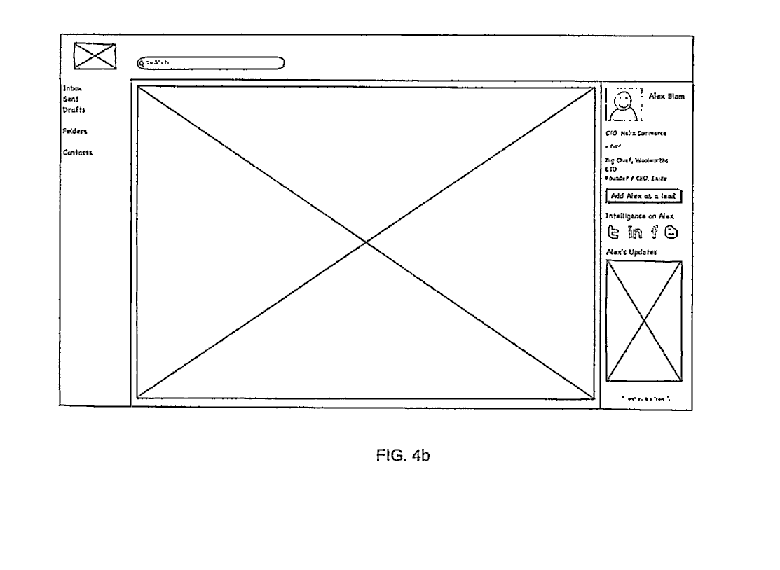

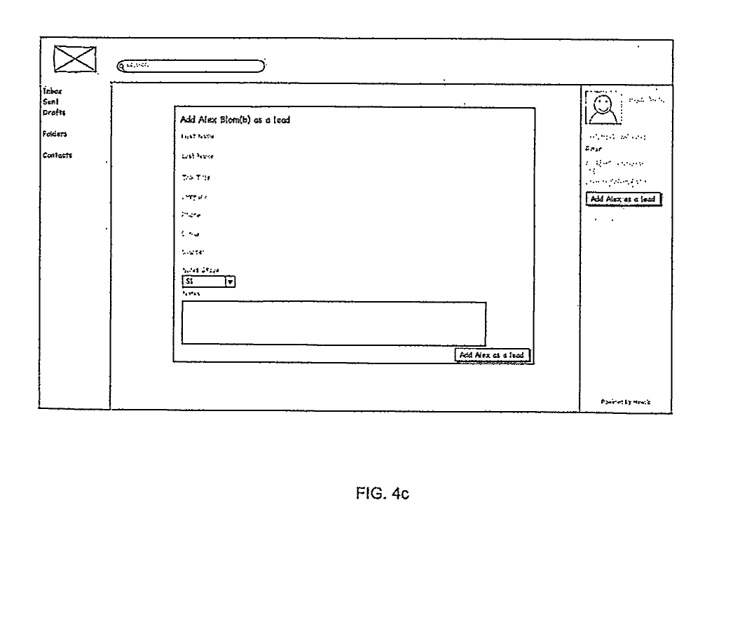

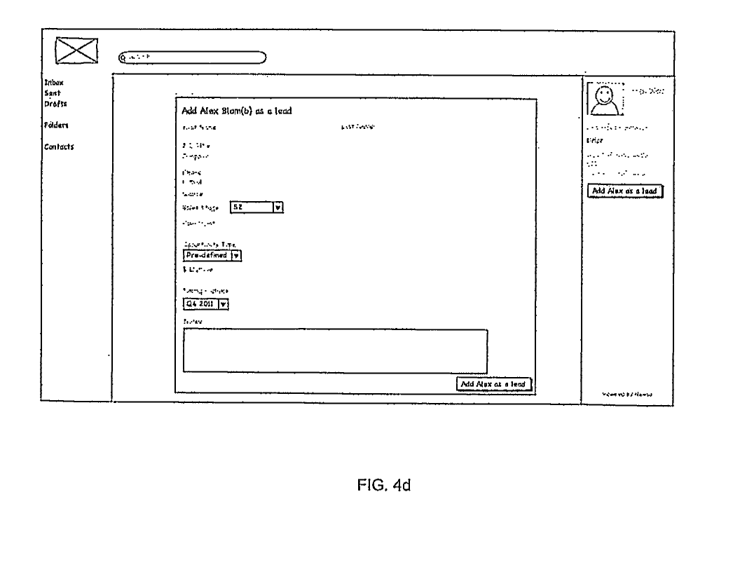

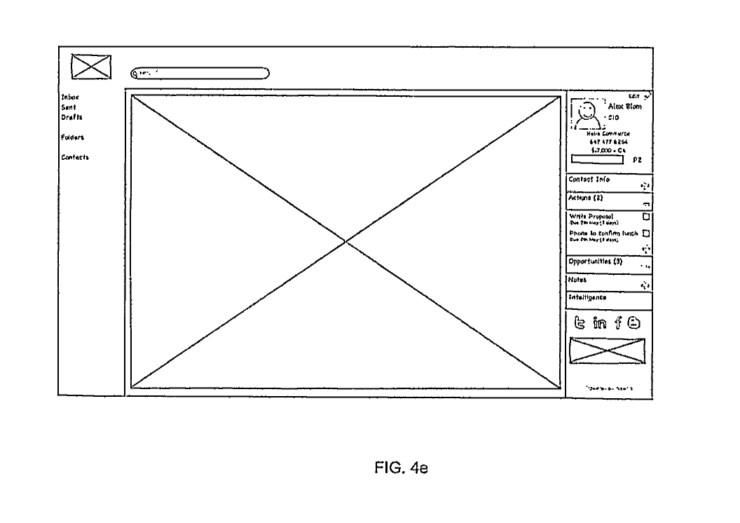

For example, integration into email applications, for example as illustrated in FIGS. 4a, 4b, 4c, 4d, and 4e at the interface level. The integration shown is enabled by the API connecting to email servers and requesting updates and synchronizing data where necessary. The system of the present invention thus enables one or more interfaces ag shown in FIGS. 4a, 4b, 4c, 4d and 4e, which involve integration of extraneous functionality into email applications for example, or presentation of custom interfaces that include in part email application functionality.

It should be understood that the distributed architecture of the present invention enables the architecture to include or link to other environments, and also enables scaling of the solution.

FIG. 3b illustrates in greater detail a representative implementation of the network architecture of the present invention. This particular implementation illustrates implementation of the present invention for a customer using an established business system, in this case a representative system referenced in FIG. 3b as “RQ4”, which is a point of sale system used to run a master contract record database and a master inventory database. The workflow management system (2) of the present invention is configured so that if a change in contact is made in the RQ4 system, then this is reflected in database (12). A sales representative of a customer of the system enters a “deal” or order such as a purchase of a defined number of mobile devices, and this initiates the platform of the present invention to connect to an inventory system to confirm that inventory is available and in stock. In accordance with the processes of the customer, a different division may be in charge with managing shipping, in this case also using RQ4. The system of the present invention is operable to automatically inform the sales representative that 1) a customer order has been shipped and 2) the customer order was received, data that was not prior available. In the case of the customer, the customer's own clients may place an order for example for 1,000 devices but may commit to accepting delivery over a defined period of time for example. The system of the present invention may create a custom screen that is populated by up to date information from the RQ4 system providing indicating how many mobile devices have been shipped to the client as compared to the total order, and therefore the progress of this order can be tracked from a fulfillment perspective and also from a financial perspective, possibly using yet another financial tracking application that normally cannot interface with RQ4 directly. This enables for example the calculation and payment of bonuses more efficiently (saving money for the customer) and also more quickly, thereby providing more direct and therefore more effective sales incentives to sales personnel of the customer. In this particular implementation, a custom data capture application (23) is linked to the RQ4 system to enable automatic extraction of information from the RQ4 system to support the workflow described.

Using prior art systems or approaches, this integration would be much more difficult and perhaps would not be feasible. The present invention, including the architecture explained and the use of this architecture as part of one or more customer centric workflows, enables rapid and cost effective deployment of across multiple systems, applications, and databases in a novel and innovative way.

FIGS. 4a, 4b, 4c, 4d, and 4e illustrate representative interfaces for implementing the system of the present invention, and more particularly the integration of sales automation related processes into use of an email application, using the system and method of the present invention.

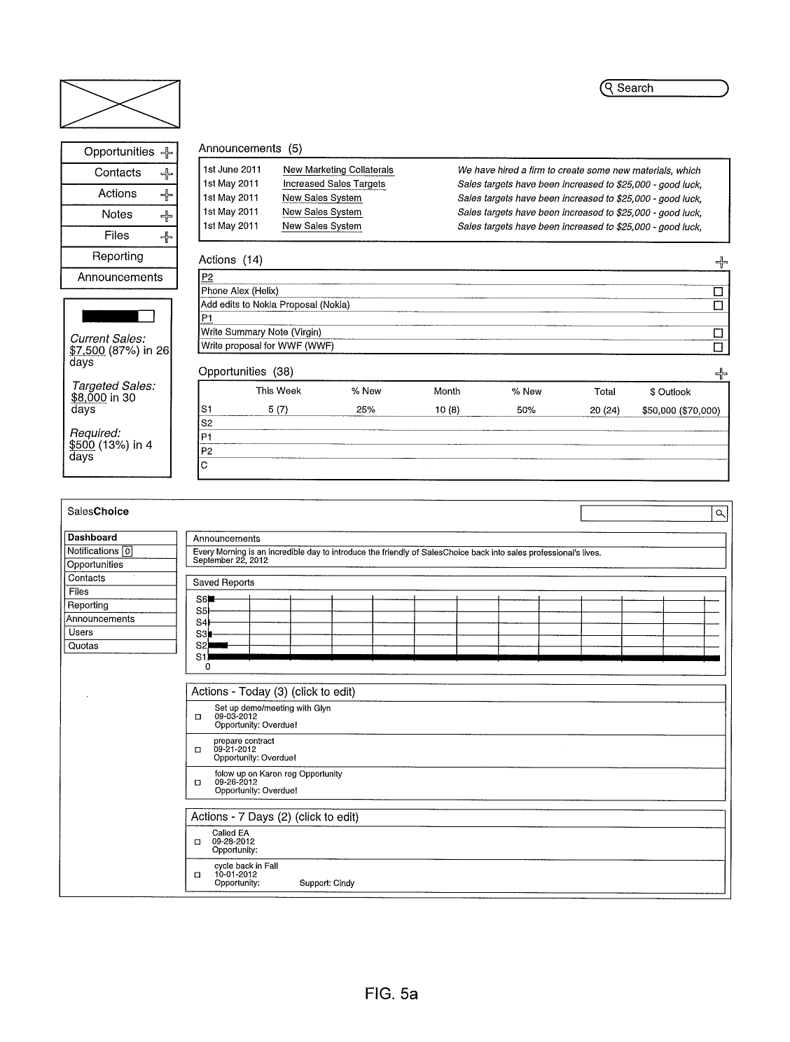

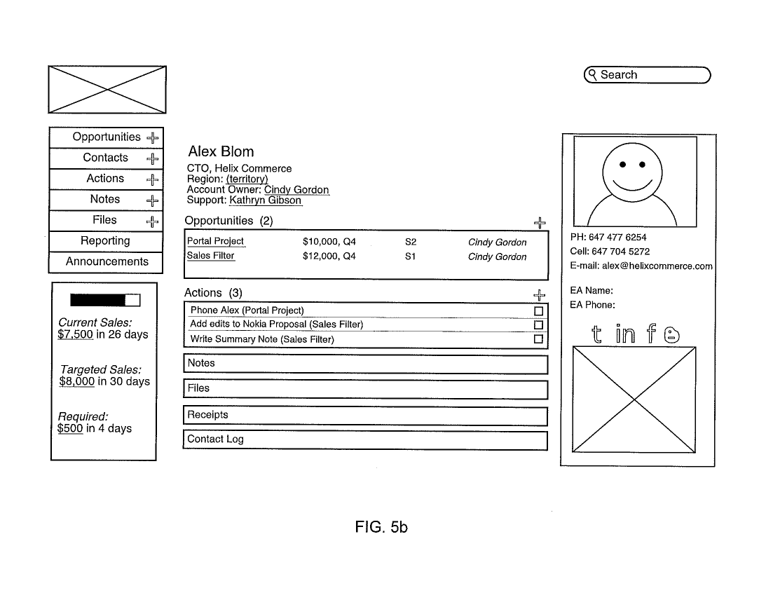

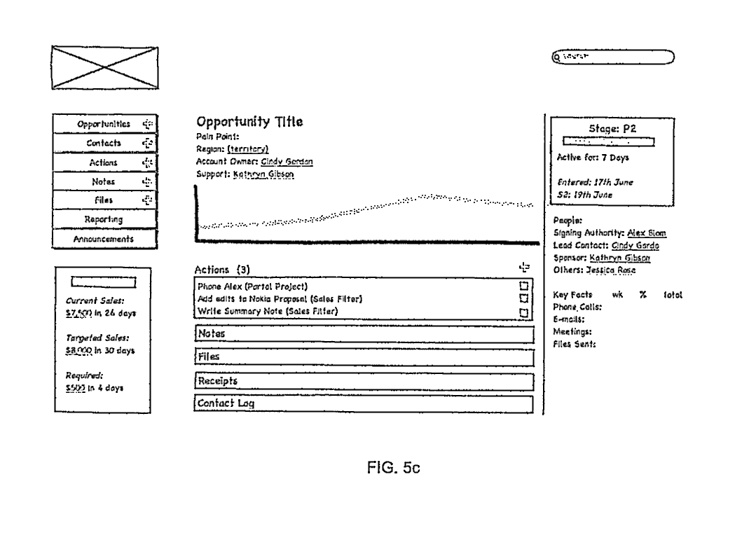

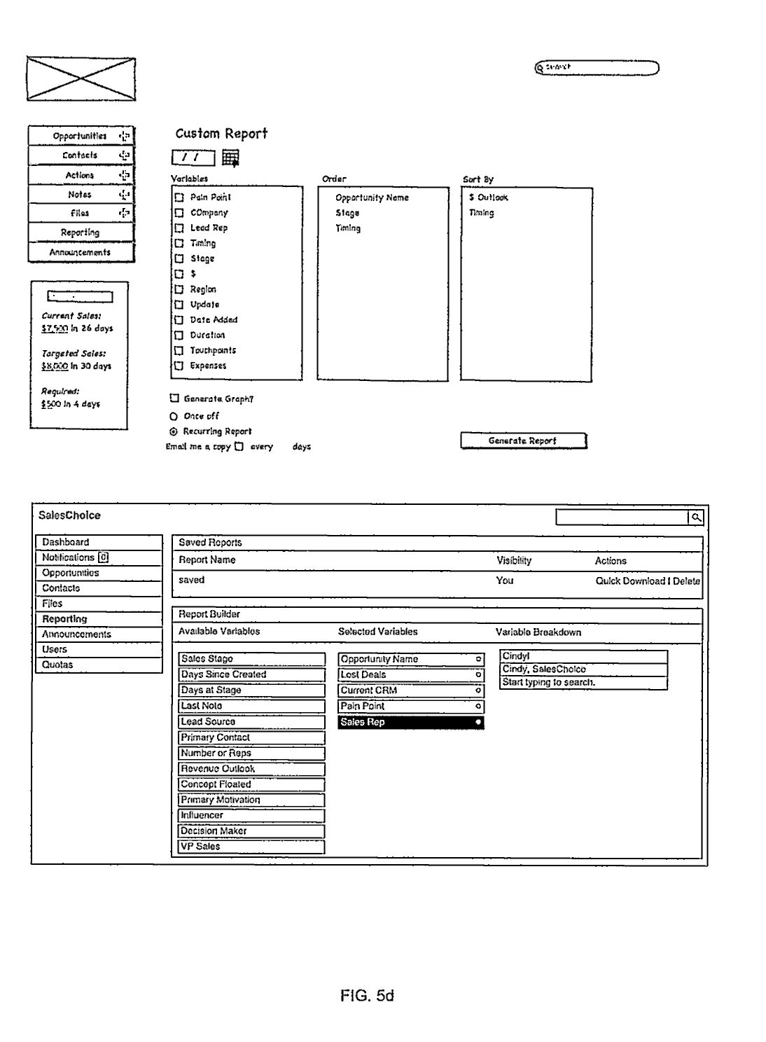

FIGS. 5a, 5b, 5c, and 5d illustrate an alternate embodiment of the invention, in which sales automation processes are provided using a web portal enabled by the present invention.

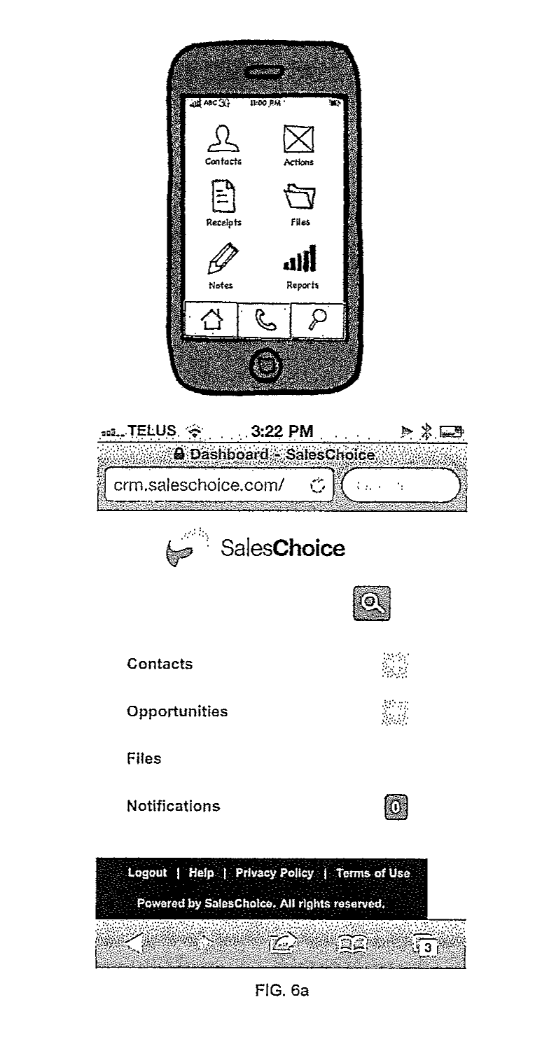

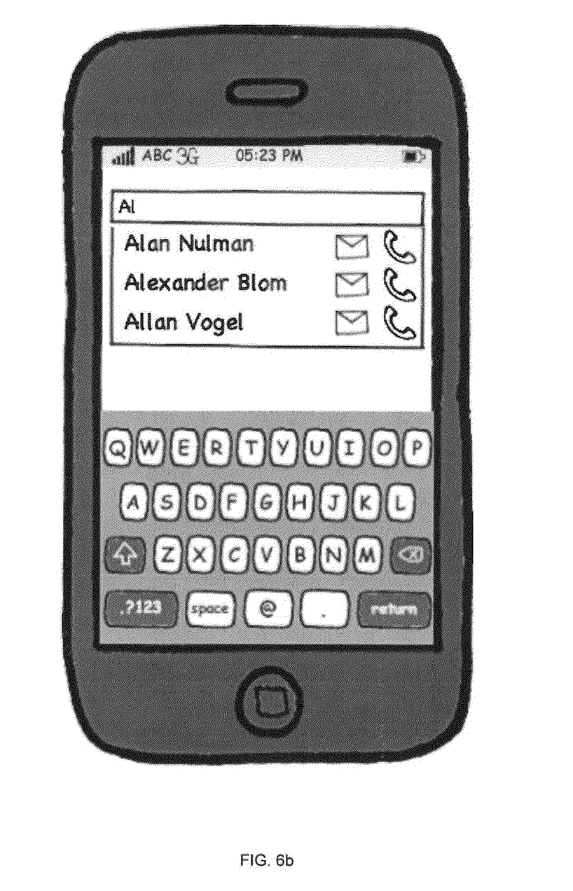

FIGS. 6a and 6b illustrate representative mobile application screens that show the mobile access to data and functionality enabled by operation of the system of the present invention.

The cloud based system may be hosted in two parts: a production site and a working backup site that enables traffic to be redirected as needed if things fail.

The cloud based database (12) of the present invention may replicate data from linked applications or databases within the one or more system environments integrated by the architecture of the present invention using MySQL's built-in replication system from the production to the backup systems. The working back-up may also include a copy of the API, website, data connectors and local applications. When files are uploaded to the API and entered into the cloud based database (12), these may be uploaded to Amazon's Simple Storage System (83) and replicated to the backup system as well.

It should be understood that all applications may integrate with the API (16), providing uniform connections across the various applications linked to the system through the API (16), including the web portal (18) enabled by the present invention.

The web portal (18) is the first front-end to data provisioned by operation of the present system. The web portal (18) connects to the API (16) to perform all actions. For optimization, the web portal (18) may share the same object cache with the API (16) and will check there first before making unnecessary API calls. The web portal (18) may allow users to create and modify contacts, opportunities, announcements, and actions, as well as upload documents and create custom reports.

The web portal (18) may use auto-completion on search fields such as contacts, opportunities, files. The web portal may integrate with the “custom forms”; for example, if a field corresponds to a contact, the system may be operable to search the database for any contacts that match the entered data so far to suggest options.

In an example of the implementation of the invention, local applications may include an OutLook™ sidebar or a Google Apps integration. There are a few different states to a local application including a default state, where there is no single contact or email selected. This retrieves general information on a user's actions, tasks, etc. Once a contact or email is selected for example, the workflow feature objects (13) may check with the API (16) to see if the sender corresponds to a contact/opportunity in the system and will display relevant information.

The connections to local applications (14) may be provided using data connectors (20). For example, in one implementation, the system connects to the email servers from the cloud infrastructure and downloads message headers. These are checked against the client's known contact list, and any messages that need to be recorded for contacts in the system are downloaded, including any attachments. These data connectors (20) download and queue messages and attachments to be logged, and they are then sent in the order that they are downloaded to the API (16) to be entered into the database (12).

Data connectors (20) may be implemented in a number of different ways. For example in relation to EXCHANGE™, a data connector (20) may be implemented using (i) a connection to the server, (ii) use of a plug-in that logs in and remotely extracts data based on email headers, or (iii) emails may be obtained using a sidebar application integrated into OUTLOOK™.

In addition to data connectors (20), the present invention also contemplates the use of one or more data capture applications (23) which may be implemented as custom applications, configured to connect to existing business systems (4) to download and synchronize data. These data capture applications (23) may reside in the cloud infrastructure so that they can scale on an as-needed basis to meet client demand. Much like the data connectors (20), these data capture applications (23) will be individually responsible for downloading and queueing data, and sending relevant data to the API (16) layer to be entered into the database (12).

In one possible implementation of the present invention, the computer system may include one or more crawlers that are adapted to collect information from a variety of sources in support of various platform features.

In one aspect of the invention, a skilled reader will understand that for example a crawler, the analytics engine (30), and the various workflows configured using the present invention may enable the provision of an intelligent sales agent that automatically undertakes a number of manual processes currently undertaken by human sales agents, usually across multiple applications and following using inefficient and time consuming processes.

It should be understood that this enables require data to be automatically logged to the database (12), if this is required for optimal implementation of a particular workflow feature object (13). For example a particular workflow may require ready access to email and associated attachments. Accessing email and attachments directly from the associated email application in support of a sales related workflow may not be possible, or may not provide adequate performance. Based on operation of the present invention, a data connector (20) is configured to connect to the email platform, or possibly a data capture application (23) is configured to connect to the email platform, in order to enable the data access management utility (22) to obtain selected email and associated files (such as attachments), and log these to database (12). Once logged to database (12), the email and associated files are made available to the various workflows enabled by the workflow management system (2). It should be understood that the data access management utility (22) may not only log emails and associated files but also is operable to obtain and store to the database (22) associated meta data such as the length of emails, time sent, time responded, time received, email chain information, sentiment, and so on. This information may be analyzed by the analytics engine (30) referred to below for example to enable macro reporting and analytics. For example the analytics engine (30) may analyze such information to generate information (which a reporting utility (28) is operable to use to create on e or more reports) regarding performances of sales people for example relative to one or more objectives regarding timeliness of email response, and other factors.

It should also be understood that data access management utility (22) may be operable to extract data upon it being created or logged by local applications (14) for example. In one implementation, email received by an email platform that is part of the business system (4) is logged to the database (12) automatically upon receipt by operation of the data access management utility (22).

Clearly, the architecture of the present invention and the workflows that it enables result in what some may consider redundancies, e.g. the replication of email on the database (12). However, this enables ready access to data such as email required for sales and marketing related workflows, using for example a mobile application loaded to a mobile device that a salesperson takes to a client meeting.

One advantage of the invention is that system is “nomadic” in the sense that users may access functions of the architecture, and applications made part of the architecture anywhere by logging into an application linked to the architecture.

The present invention may also be operable to initiate one or more resources to access external data for example for the purposes of accessing social intelligence and lead intelligence, and incorporating the resulting information into one or more workflows enabled by the present invention. For example, upon a user opening an email, document or lead information for a sender/recipient who is detected as being a potential lead, the present system automatically connects to various data sources (for example Twitter/Social media, CRM data), as well as completes a public web scrape based on the email, to compile intelligence automatically that based on the prior art would not be available this way or would require manual searching. It should be understood that part of the changing environment described above that impacts on the need for new workflows, or changes to workflow, includes the need to incorporate new data sources such as Twitter™, or to use such data sources in a new way. The present invention for example enables the system to be reconfigured easily to scrape external sources such as Twitter™ and LinkedIn™ automatically to extract data that may be processed and pulled into one or more workflows that benefit from information from these data sources.

For examples the present invention enables data regarding the status of individuals, delivery time and many of other states to be obtained from external real time or near real time system dynamically, and integrated into one or more existing workflows deployed by the system of the present invention.

The present invention is also operable to automatically upload files and other important documents. The system is operable to analyze activities of users and automatically interpret activities using an analytics engine (30) to determine intent and as an outcome for example automatically retrieve files or other information, or send to customers for example.

The mobile application (24) may permit a number of functions such as receipt entry by taking a photograph, and by operation of the automated data flow manager (8) the system automatically sends the information to the appropriate application/database in order to create an expense log with a photograph of the receipt attached.

In another aspect of the implementation of the present invention, an administrative user may define certain documents that sales personnel will for example use in client visits. These files may be accessed automatically using the “FILES” icon of the mobile application (24). For example, the automated data flow manager (8) is operable, when the mobile device (26) is in an area where optimal wireless connectivity is available, to push one or more files or updates to files to the mobile device (26). The files in question thereafter are made available locally on the mobile device (26). Alternatively, the “FILES” icon may be operable to provide a mechanism to download selected documents in real time from database (12) for example, on an as needed basis. This allows mobile sales personnel to have documents for presentation to customers, when they need them.

The mobile application (24) may be further operable to provide users a series of features for displaying information, and communicating information to customers or potential clients or potential clients. For example, a user may tap the “FILES” icon twice which causes the mobile application (24) to retrieve the contact information for the client contact or client contact lead. Upon confirmation, the mobile application (24) may communicate with the API (16) to request that one or more files be sent to the client contact or client contact lead. The mobile application (24) may retrieve the files (for example from the database (12) or local applications (14). This permits large files to be made accessible in a convenient and efficient way.

Also, the mobile application (24) may be configured to read the client participants in an upcoming meeting and automatically retrieve relevant information for the meeting or participant which may include recent correspondence, recent sales information for the client, automated retrieval of information from social networks to obtain personal information for the user (in order for example to foster a personal connection).

The system of the present invention in compiling relevant information may apply one or more techniques for summarizing or digesting relevant information, including document summarization for summarizing relevant documents for quick perusal prior to a meeting, or generation of an interest cloud which consists of analysis of relevant information (for example relevant emails, removal of repetitive wording, to extract selected themes that appear to have significance. The system of the present invention may also include a semantic analysis engine (27) which may assist in the processing of information for example to generate one or more tag clouds reflecting for example an efficient summary of client concerns, extracted from client communications, client websites or social sites.

In another aspect of the invention, the workflow feature objects (13) include an intelligent task tracker (not shown). When a task is generated and associated with one or more individuals or organizations, for example when an employee wishes to send an email to a particular individual or organization, the system is operable to check whether there are outstanding tasks for the individual or organization, and the before an email is sent, the employee is asked if the task has been completed. Alternatively, the semantic engine (27) may be configured to analyze incoming email and identify if a customer request has been included, and if there has been then the system automatically generates an applicable task. Once the task is in the queue reminders may be sent until the item is completed.

The system may also be link to a PBX (34) to provide stronger phone tracking. The system may also include enhanced unified messaging features whereby communications of any form involving particular contacts may be stored to a particular file automatically. This permits improved tracking and analysis of communications and associate sales activities. Tracking and analysis may also include analysis of communications for sentiment, for example using solutions provided by LYMBIX™.

In another aspect of the mobile application (24), photographs may be taken of business cards, and these are recognized as business cards are and automatically transferred to a particular destination for analysis, for example scanning and conversion to text for input to a CRM platform. More particularly, the system may be operable to pre-fill a CRM new entry form, and the system may remind the user to complete information at a later date.

In another aspect of implementation of the present invention, photographs of business cards may be captured by operation of the mobile application (24) and may be stored directly into a CRM system linked to the system of the present invention.

It should be understood that the logger (15) as stated earlier is operable to log all activities within a defined domain. For example, the logger (15) may be configured to define a range of activities which the administrators of the system want to monitor. The logger (15) compiles information which then is made available to the reporting utility (28) to enable the generation of reports, in this particular example related to sales performance. The reporting utility also enables an administrative user for example to generate one or more queries which are processed by a data access management utility (22). In this way an administrative user may query the database (12) to determine for example how quickly a salesperson responds to emails from leads. The reporting utility (28) is operable to generate reports on average response times across a sales group, and compare this to individual results.

The system of the present invention may also include an analytics engine (30) that is operable analyze data related to sales activities and apply analytics for example to define trends, suggest best practices, identify insights or trends, identify in real time tops sales persons, determine sales strategies that work best for certain products or certain types of customers. Once these patterns are identified, these can be integrated in sales activity monitoring enabled by the present invention, for example a salesperson may be sent one or more notifications designed to alert the salesperson if they are diverging from a pattern that has been established as being optimal in certain circumstances. One example of a workflow feature object that constitutes a pop-up screen that informs a salesperson that “when you send an email at time x, leads have 30% less chance of closing. If you send file X at this stage, leads have a 20% higher chance”.

The analytics engine (30) may also measure external factors on leads to identify opportunity contact times, moods, etc. The system of the present invention may be configured to analyze social trends to see when a ‘burst’ of activity is made, thus assuming the person has more free time then and it is an opportune time to contact them regarding sales. The analytics engine (30) may also incorporate one or more personality profiles, and after a personal profile for a particular customer target is a built, the profile data may be compared to the personality profiles so as to establish sales related personality traits of the customer target. This information may be used for example to match a salesperson to a customer target for optimal business generation, or for the system to tailor sales strategies for the customer target which may be reflected in a lead generation system (36) linked to the system of the present invention.

It should be understood that the present invention may be used to enable the implementation of workflows across multiple local applications in other domains as well. For example a venture capital firm normally receives many requests from companies. A workflow may be designed defining what information must be provided, what must be reviewed by whom to determine whether a company moves to the next stage an in the review process.

In another example, in a law firm or an accounting firm, client intake may involve certain file opening procedures, including collection of specific information, providing certain documents to the new client, generation of a retainer letter, tracking of receipt of retainer, opening of files in a DMS (Document Management System) and so on.

Example of the Method

In one aspect of the invention, a method is provided for enabling one or more administrative users to design and implement a workflow that leverages resources of one or more business systems (4), in a flexible way, and based on dynamic business requirements, without the need for significant integration with the business systems (4) or associated databases. The workflow may be used from a variety of different devices, and significantly from mobile devices, again without the need for significant integration. This enables the use of mobile devices for deployment of workflows with flexibility and efficiency that is not possible using prior art solutions. It also should be noted that the workflow designer (6) in one aspect of the invention may be used by administrators on a regular basis to continuously deploy new workflows or changes to workflows to adapt to the changing parameters referred to above.

In addition, it should be understood that the workflow management system (2) may be used, relying on the analytics engine (30) for example to identify possible improvements to workflows, for example by comparing existing workflows to a set of best practices stored to the database (11), whether these best practices are based on the client organization or derived from similar organizations or similar businesses recognized as being leaders in the same domain. The workflow management system (2) of the present invention enables the “tuning” of workflows in part based on output from the analytics engine, which may be generated automatically or based on one or more analysis routines or queries selected by the administrative user by operation of an appropriate user interface.

It should be understood that the implementation of the system of the present invention may involve a consulting phase. In one aspect of a method in accordance with the present invention, personnel of the operator of the system of the present invention, or a contractor, may follow the following process:
(1) General information is obtained regarding the system environment of the customer, including for example the business systems (4) and particular configurations thereof used. For example, it is established whether the customer uses MICROSOFT EXCHANGE™ for email, or another email technology. It should be understood that the system environment information may be obtained using a checklist, and this checklist may be implemented as part of a customer set up utility that is part of the web application (10), and may be part of the workflow designer (6).
(2) Information is obtained regarding the one or more relevant workflows of the customer, where use of the system of the invention is desired, or may provide benefits to the customer. For example in a sales process the contractor may obtain information regarding the principal stages involved in the sales process of the particular customer, and specific action items or information that may be involved in each of these stages. It should be understood that the customer set up utility of the present invention, which is part of the overall workflow designer (6), may implement one or more workflows related to setting up customers on the system of the present invention. For example, based on the type of business, and sales related attributes or objectives, the contractor may begin with a set up template which is modified based on for example discussion with key sales personnel and executives of the customer organization. For example, the contractor may establish the specific parameters of “ADDING AN OPPORTUNITY”, including information required from business systems (4), information to be provided to business systems (4) automatically, associated business rules and so on.

The design of the workflow may result in reduced data entry, or other reduced duplication, which is a significant drain on resources especially in sales environments. It should also be understood that adherence to processes is important, including in sales environments.

However, duplication and time consuming data entry tends to be an obstacle to adherence. By streamlining sales processes by operation of the customized workflows of the present invention, with easier or dynamic integration with existing systems, adherence to important processes may be improved significantly by operation of the present invention.

It should also be understood that customers may use the workflow designer (6) and the customer set up aspects thereof to design their own workflows.

The analytics engine (30) may be invoked by the workflows designed to generate analytics data that supports one or more aspects of a sales process for example, and the analytics data may be dynamically inserted into the customized web pages enabled by the web application (12). For example the analytics engine (30) may calculate real time “probability of closing” a sales opportunity which is inserted in relevant screens to further assist the customer, and sales personnel, in meeting sales objectives.

Workflows implemented by operation of the present invention may enable the tracking of all communications between sales personnel for example and contacts earmarked as being part of the sales pipeline by operation of the system. The system of the present invention may be operable to analyze the communications, digest the communications, assess communications to identify ones that require follow up or that are most relevant to one or more steps in the sales related workflow. The results may be dynamically displayed by operation of the invention.

(3) Workflows are enabled by operation of the workflow management system (2), based on the parameters identified through (1) and (2) aspects of the method described above.

The workflow designer (6) may be implemented as a menu builder, in which one or more drop down menus are provided for identifying workflow parameters, selecting related actions, and provided required data such as tags for fields or instructions to sales personnel.

Representative Use Cases

Two use case examples are provided to illustrate the operation and use of the present invention.

Use Case 1: Hardware Sales

Hardware Company A sells widgets X. As part of selling widget X, a sales representative either receives an incoming (warm) lead or cold calls a switchboard, and it is assumed that the sales representative visits the client site at least once to show widget X physically. At a high level, the sales steps may include the following:
1: Suspect—5% Probability (of closing the sale)
2: Prospect—10% Probability
3: Lead—25% Probability
4: Opportunity—50% Probability
5: Deal—100% Probability

1: In these sales stages, Suspect is where the organization has not yet contacted the individual being sold to, but has done some basic background research. As such, the sales representative has to enter the name of the individual they intend on calling (as a contact file, meaning contact details are also collected if they do not already exist), fill out a small text box titled application (why would the company use this widget), which is to force a sales representative to understand what product spin to use, as well as highlight a drop down box called “territory” and select a territory for territory management. If the sales representative selects a territory they are not assigned to, the lead will be re-assigned. The sales representative will likely enter this information through the web application (12), however if the lead was warm/an email referral, it is highly likely they will add this information via the email client.

2: To become a prospect, Company A may dictate that you must have spoken to the customer, received a validation that your pain point was correct, and have a meeting booked. In this case, our sales representative phones the client for a high level pitch, speaks about the product and validates the pain point (this call is automatically tracked by operation of link to the PBX (34)). The representative then sends a summary email to the client to confirm the time (also automatically tracked) and receives confirmation via email. The web application (12) may present an email side bar that has been pre-loaded the Opportunity data based on the email address, the sales representative advances the lead from their Microsoft Outlook or Google Apps (could be other clients later).

3: The lead stage may involve the sales representative being required to do an in person demonstration of the product on the date booked in the prior stage. As a result, a notification appears in all systems part of or linked to the system of the present invention, for example within 12 hours of the meeting, reminding the sales representative to update their records. For this organization, a lead may simply require a receptive in person widget demonstration where a proposal is requested outlining price. During the demonstration, the sales representative may be asked to check on widget shipping times. Prior to the automated 12 hour reminder, and as soon as this meeting is complete, the sales representative opens their mobile application, finds the opportunity and advances it to the ‘Opportunity’ phase (as a demo has been completed) and adds an action (due within 2 days for example) to check on shipping times and report back to the client. As the stage is advanced, this organization also automatically populates an action for the sales representative, which is to write a proposal document within 3 days of the lead being advanced (example of automatic action creating).

4: In the Opportunity Stage, the sales representative writes a proposal. They have already completed the prior custom client action to check on shipping times, and followed up with the client. As the proposal is completed, the sales representative emails it to the client. The sales representative then sends the proposal to the client (which is automatically uploaded to the CRM) and updates their opportunity accordingly.

Use Case 2: Software Company

Company B is a software company with a very specific application, a well defined client set, large deals and an inherently mobile salesforce. Instead of a solo representative, this sales cycle involves many individuals both internally and externally. This is an example of an inbound lead, vs. the more lead generation based example before. Company A may have the following steps:
1: Lead 5% (probability of closing)
2: Solution Validation 10%
3: Opportunity 15%
4: Demonstration 25%
5: Technical Validation 30%
6: Proposal/Formal Presentation 50%
7: Proposal Refinements 75%
8: Deal Closed 90%
9: Deal Finalized 100%

1: The Lead phase identifies an incoming lead (which could be from a marketing filter etc., but for simplicity, let's assume the customer emailed a lead sales representative). The sales representative opens the email, and is presented with key context on the individual who sent a cold email. He notices they used to work at Xerox (where he used to work), like tennis and know Terry who works down the hallway (all automatically compiled). As a result, our sales representative speaks to Terry and gets coaching on who the lead is, their personality style, and the best path for success. Once comfortable, our sales representative emails the client back (within the 24 hour turn around target, as tracked by email response times) and suggests a time to visit personally and adds this individual to the sales funnel as a “lead”. Once the meeting is confirmed and added to the Exchange Calendar, the meeting is also automatically tracked.

2: Solution Validation is a high level demonstration/solution sell to the client, visiting them in person. The objective of this meeting is for the sales user to understand 1) The Prime Driver for buying the software (text field), 2) The Amount of Users and 3) The Influencer, Decision Maker, User and Signing Authority in the Account (all tagged as separate contacts), Once the meeting is complete, the sales representative enters this information, including the contacts and some notes about the company via their tablet or mobile applications (future state: take photos of business cards for auto entry).

3: Step 3 is the processing of the data collected (namely pain point) into an active opportunity. It is an entirely internal step, where the sales representative assigns an action to somebody designated as ‘account support’ to take the client's pain point, number of seats and to write a one page document summarizing high level costs, and the benefits/savings/efficiencies the product will deliver based on the information collected. These actions are automatically assigned with a time target of 5 days for example. During this period, the sales representative is organizing a larger demonstration meeting with the individual lead, influencers, decision makers, users and signing authority.

4: Once completed, the sales representative re-attends this meeting. On the way, while stuck in traffic, they call another sales cycle who claims to be unable to find a proposal that was written. The sales representative navigates on their phone to the client, receives a list of files that were sent back and forth and automatically sends it out.

After a successful demonstration, the sales user must receive the names of I.T. Security and Architects, to validate solution compatibility. As the sales representative was doing a laptop driven demo, he adds these as contacts in his laptop via the web portal and advances the sales stage to the next step.

The sales representative also activates a web based version for the client to continue testing/experimenting with. A tracking code left in the software shows the sales organization how many times the client has logged into this sandbox, and how long they spent there.

5; An internal technical sales support resource is automatically assigned the action to connect and validate that the solution will work. Once this user approves and does their systems testing, the deal is moved to stage 6 and the sales rep receives an automated notification.

6: A proposal is written based on prior emails, and is automatically sent to all involved. Again, it is automatically uploaded. Due to client schedules, the sales representative is not visiting again in person, but organizes a webinar where this is presented.

7: After the presentation, the client emails back some concerns, facts to check and edits for the proposal. The sales representative advances the lead to stage 7 in the email client, and automatically adds actions and assigns the relevant users from the email client. Once the client accepts the proposal, the deal moves to phase 8,

8: Deal is marked as closed by the representative. The deal then waits for an automated trigger back from Accounting, Operations and Fulfillment systems that user ID's have been created.

9: Deal is approved by CEO from their dashboard.

At any time, this deal can be marked as dead (a separate category, where the rep states reason for loss).

It should be understood that the use cases identified above enable the implementation of various processes and access to information at various points, for example from a mobile device, that based on existing systems would not have been possible or available without significant integration. The processes and information required may evolve. Also, administrators may review sales success stories and obtain insights suggesting changes to workflows. Again, these may be integrated easily, in fact changes may be “tested” on the system for effectiveness. Various other scenarios are possible using the present system that simply are not practical using prior art approaches. For example, sales personnel may be monitored more closely to identify sales personnel who do not return information within target timelines to potential customers, and further training may be provided or personnel may be reprimanded. Compliance processes may be linked more directly to compensation. Workflows may be adjusted to the personality of the sales targets and/or the sales personnel, and so on.

Insights Generation

In another aspect of the invention, a computer system is provided that includes an insight engine that leverages diverse data sources to optimize sales performance in a number of dimensions (quality/accuracy of sales funnel, predictability/probability of a sales lead closing, value/cost of a lead, and sourcing of a lead based on intelligent/predictive customer research sources). The insight engine may be implemented as part of the web application (10) described above.

In one aspect, the computer system may be implemented as a computer network resource or computer program that plugs into an existing CRM infrastructure and analyzes information from a plurality of data sources or data stores regarding activities of, or interactions between, sales/marketing professionals and their customers/prospects, and based on this analysis predicts accurately probable outcomes relative to one or more sales/marketing objectives.

In one possible implementation, the insight engine of the present invention is configured to enable improvements to sales/marketing interactions, and to deliver sales performance improvements, by generating intelligent insights based on identification of sales patterns pertinent to an individual, a group of individuals (such as a sales team), and/or an industry. In one particular aspect, the system is designed to generate insights consisting of successful sales patterns extracted from one or more associated information domains.

In one possible implementation, the successful sales patterns are analyzed by the computer system using one or more data operations in order to generate suggestions for assisting sales/marketing representatives in their sales/marketing activities. In one implementation, the computer system includes an analyzer that implements one or more analytical operations, including optionally predictive operations for determining behaviours that will promote successful sales/marketing efforts. The suggestions may be presented for example as part of a sales/marketing dashboard. The suggestions may also be integrated with a CRM and its associated functions.

The computer system may includes a series of routines or tools implementing “big data” based methods, algebraic topology, decision tree analytics, natural language parsing, text mining, and/or Bayesian networking. These routines or tools may be used to mine or track mobile device operations, calendar and/or action logs.

In another possible implementation, the computer system includes a scoring component that scores customer or sales insights.

The computer system may provide sales optimization features, based on a variety of fact based indicators which may include:
email or texting interaction patterns, e.g. frequency/duration/who/location/text of email (may include sentiment analysis)
mobile or phone interaction patterns, e.g. frequency/duration/who/location/voice content (may include sentiment analysis)
text or symbol message interaction patterns, e.g. frequency/duration/who/location/text of email (may include sentiment analysis)
CRM sales funnel activity patterns, including information logged in the CRM (expected deal size, expected closing date, type sale, terms, demonstrations, meetings, status, etc.)
social media activity patterns, including for example based on LinkedIn™. Twitter™, Facebook™ or other social media channels, including based on application of sentiment analysis thereof
calendar activity interaction patterns
action log activity interaction patterns
location interaction patterns
Third party database patterns (ie: hoovers on a company's financial status), etc.

Each of these interactions may be seen a sales/marketing “touch points” or interactions between customers/prospects and sales/marketing representatives that may be relevant to the advancement of a sales/marketing objective. These interactions can be used to determine the quality (effectiveness or efficiency) of the prospect/customer relationship at a particular time. All of these interactions contribute to a domain of information that may be analyzed in real-time n order to provide productivity or sales optimization insights.

In one aspect of the present invention, these interactions are logged to the system for a plurality of sales/marketing professionals, in a way that they are associated with one or more sales/marketing objectives. The interactions are time stamped, and the analyzer is configured to analyze interactions across a sales/marketing process with an associated timeline, and further to compare associated sales/marketing processes and associated interaction elements to derive insights.

In one aspect of the present invention, the computer system enables accurate sales forecasting, which is important for managing growth and risk. Worldwide, sales leaders, have reaffirmed that their top priority is to increase their sales effectiveness (56.3 percent) followed by increased revenues (51.9 percent) (Accenture, and CSO Insights, 2012 Study >250 respondents USD $1 B in sales). The definition of sales effectiveness and the ensuing strategies and tactics that organizations take to achieve it can vary considerably. For many sales effectiveness means improving sales productivity and quota attainment. For others, it is about reducing the sales cycle or the cost of making a sale.

Some reports estimate that between 36 to 47 percent of sales representative have failed to reach their annual sales quota numbers. The difference between quota attainment in 2011 and 2012 is less than one percentage point, a clear indicator that the business market recovery in NA is helping sales organizations to achieve their goals (Accenture and CSO Insights, 2012 Study).

In addition, the average time for a new sales representative to be fully productive is 7-12 months typically and they cannot see or experience in real-time the interaction patterns of all the insights of quota performing sales reps to give them a pulse check in real time of what works, what doesn't work, based on historical indicators, but also real time indicators of current activities.

The present invention in contrast for the first time provides a compass that is designed to be used by sales professionals to drive more effectively their sales activities, giving them insights that were not available before.

The computer system of the present invention leverages in part mobile tools and geo-location to automatically add context to interactions and to track communications/activities automatically that may related to a sales/marketing interaction, rather than relying on activities logged to a CRM for example when it is well known that not all activities are logged in this way.

The present invention addresses a number of effectiveness/efficiency issues that are present in prior art systems and that prevent accurate sales forecasting, namely:
sales processes and methods are not customer centric,
sales tool adoption issues because of complexity of lack of intuitiveness in user experience,
sales talent acquisition and retention practices.

In one aspect, the computer system includes one or more tools that are designed to minimize the effort requires by sales professionals for example to log actions to the platform.

In one aspect of the invention, the insight engine is designed to that it is based on scientific analysis of behavior traits that are relevant to sales/marketing professionals achieving sales quotas reliably. In one aspect of the invention, the computer system embodies a series of rules that reflect understanding of sales processes, and how sales objectives are generally met by sales/marketing professionals.

As an example, commissioned sales reps that have quarterly and annual quotas often choose the wrong activities to work on resulting in targets being missed. The computer system of the present invention generates suggestions and alerts in real time or near real time that provide immediate guidance to sales/marketing professionals so that they can better direct their immediate actions so as to improve performance relative to sales forecasts. The system operates on a dynamic and iterative basis so as to guide the actions selected by sales/marketing professionals in a granular fashion, including potentially on an activity by activity basis. The computer system presents highly relevant alerts that help sales/marketing professionals mine their sales cycles more intelligently, triggering sales/marketing professionals to engage in the right activities, directed to the right opportunities/customers/targets at the right time.

It has been shown that in certain circumstances the present invention enables an increase in sales quota achievement and realization of around 20-30%.

In certain aspects, the present invention provides:

(A) A system and method of querying, extracting, transforming and loading of data from disparate/diverse data sources representing business systems;

(B) A method of storing disparate data in a fact format that is easily consumed, augmented and calculated;

(C) A method of processing facts using various algorithms both in batched and real-time implementations to produce insights that are not evident in plain sight; and

(D) A method of coalescing the insights and refined facts into set of results that can be used to share, alert and prompt the user in order to better understand and improve the overall results of the sales process.

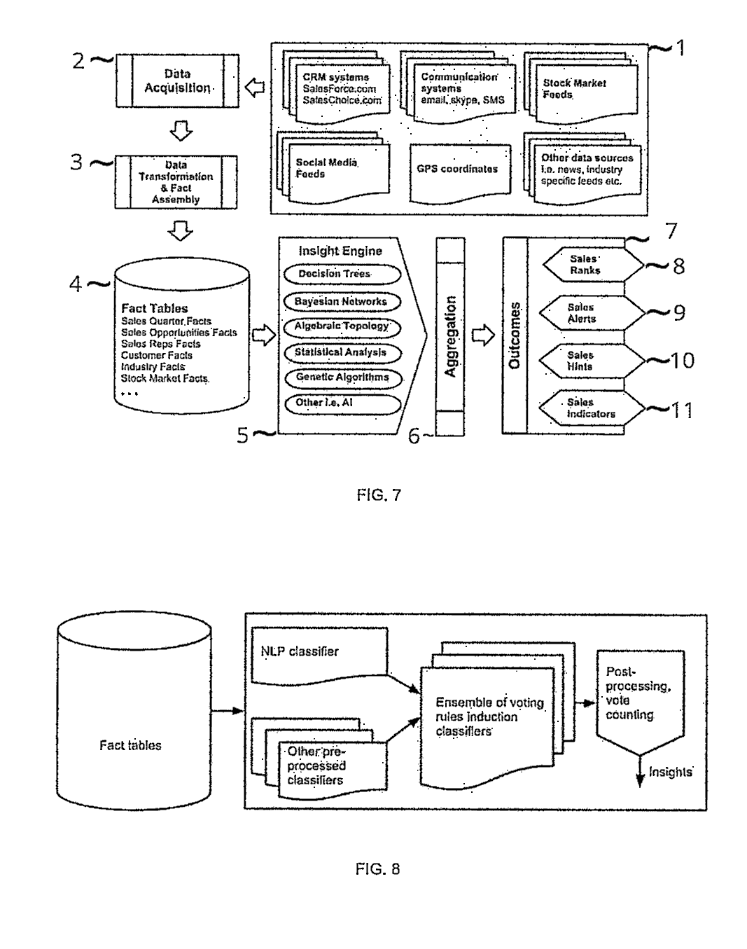

FIG. 7. illustrates the overall flow of data in the invention as data goes through these successive stages.

A variety of data sources that are relevant to a sales process may be used for example:
Any data entered by the representative about the opportunity in the CRM software (stages/questions) and meta data (date questions answered, for example), in any of the available CRM interfaces (desktop, mobile, texting . . . ).
Any communication between reps, marketing reps, service reps etc. and prospects: full data with conversation text when possible (any textual communication: email, SMS and similar), or meta data when the communication is not in text format (phone call, Skype call, etc.) is recorded as: sales representative identity+prospect identity+date of communication+communication duration.
Any recorded meeting data between prospect and representative (meta data: attendants, meeting date, location (customer, selling company, third location), duration, and if available, meeting notes).

FIG. 8 illustrates a possible implementation of the identification of classifiers, as described herein.

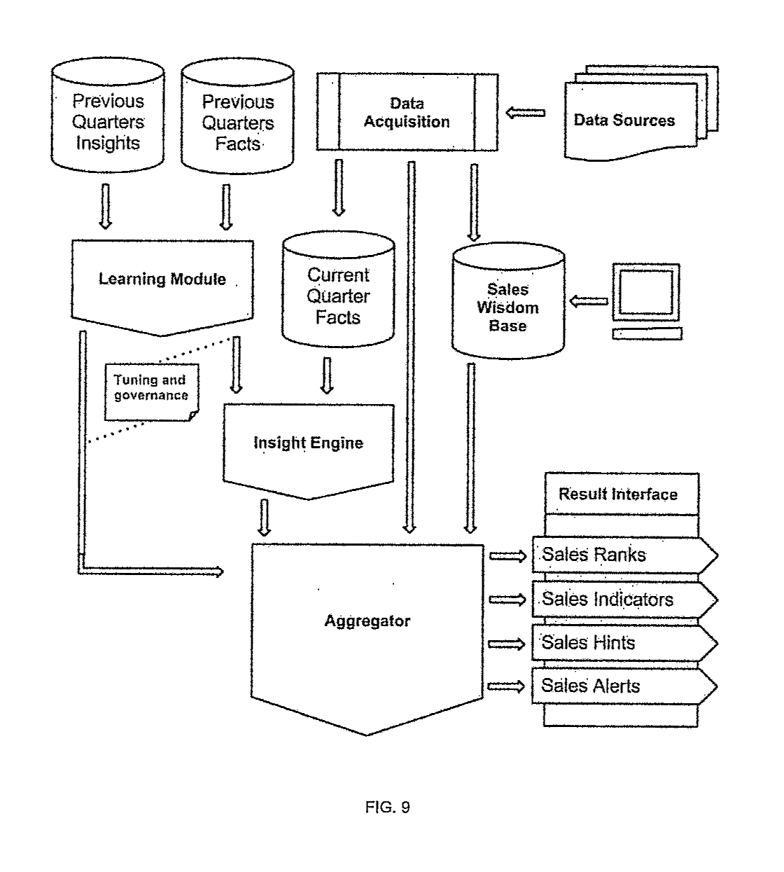

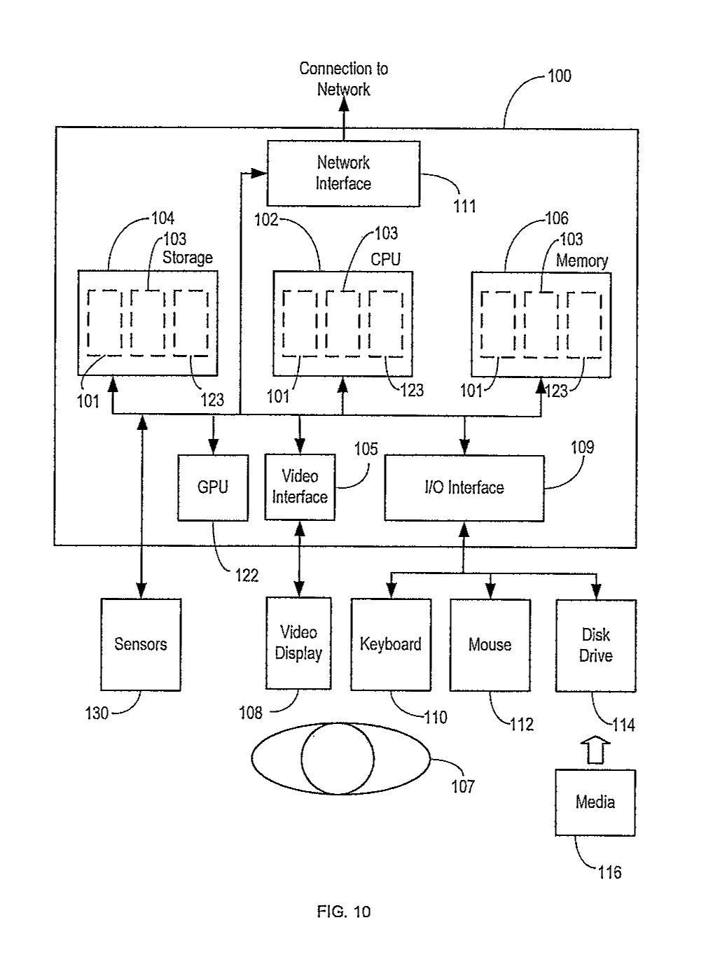

FIG. 9. illustrates the various way the system gathers useful data.

The computer system of the present invention may include a reporting utility that generates a series of useful and innovative reports using insights from the insight engine. For example, the insight engine may collect and compare thousands of interaction patterns from a variety of data sources, and calculate a sales reliability index that can be applied to sales forecasts, in order to “normalize” sales forecasts based on a realistic prediction of performance. Sales reliability indices may be defined for an individual, a group, a company or an industry, in part using trend discovery techniques across relevant information domains.

Examples of the types of novel and innovative sales quota or optimization growth insights generated by the present invention include:

For use by the sales representative:
1. At this time, your buyer's propensity to buy is within the next 30, 60, 90 days based on external indicators sourced, by example, social activity on the web, conversation patterns, business indicators of company, sentiment in text messages or email, responsiveness of email interactions.
2. Your meeting with customer XYZ is in 30 minutes, here are the latest updates about the company and the individual—XYZ facts to help prepare a sales professional to be more informed easily on a sales call as the SalesGPS sends this information to the representative prior to a direct face to face, based on alert settings the sales reps asks its salesGPS (or like a SalesGenie) acts out.
3. You have not had a call with your top 10 deals/accounts in the last XYZ days (the assistant would provide contact names, and phone numbers enabled with a click to call feature to support call activity ease)
4. Correlating all the highest performing quota bearing reps history of sales activities against current behaviors to provide an indication of being on or off course in terms of odds of success given historical indicators based on mathematical reliable indicators
5. Providing a visible pathway on a SalesGPS to demonstrate the sales cycle patterns that are the fastest way to achieve quota based on a number of real time indicators and external factors
6. Your ideal customer buyer profile is X, Y, and Z, and sourcing of leads relevant to your queries is surfaced, or patterns of alerts to engage are forwarded to inside sales reps to engage based on source insights.

For the safes manager:
7. Show the patterns of the highest performing sales reps activities/behavior across different activity types that are meeting quota plans, and displaying a sales reps quota pattern vs high achiever patterns; visualizing when a sales representative is on track or off track, with coaching triggers embedded into the software based on leading practices, or allowing a company to engage in real time or customize standard coaching patterns (Like a SalesGPS).
8. Providing a better picture of how the quarter is looking, by analysing each prospect in the funnel and assigning a probability of success.

In one aspect of the present invention, the computer system includes a series of rules that are configured based on data science techniques (such a pattern recognition and machine learning) selected and applied based on knowledge of specific sales processes, and sales intuition. These rules may be configured using a rule generator, or by selecting a template of rules and using the rule generator to adjust parameters. The computer system automatically select applicable rules based on one or more matching operations, and applies the rules to generate insights. Various associated data processing techniques may be used.

The rules enable improved prediction as to whether at a given stage if an opportunity will close or not.

In one implementation, the computer system implements a configuration step where the data sources that are available to be used as input are identified (FIG. 7—label 1) and are accessed (through secure means).

The source data gathered by a data collection system cannot immediately be used to generate useful predictions. The data in one implementation may be transformed (FIG. 7—label 3) where the data points are correlated to establish relevant facts, on which predictions will be based.

For example, an exact date (e.g. the expected closing date for an opportunity) has no importance in itself and cannot be used to discover patterns in the data, but the duration between opportunity creation and expected closing date has more meaning (is it 10 days, or is it 200 days?). Similarly, the address of a meeting location has no importance in itself, but knowing if the meeting was held at the client's, at the selling company, or in a third party location may have more meaning. If a sales reps has multiple text, email or voice mail direct interactions/conversations, of a specific duration/length, and limited data entered in the CRM tool other than registering or logging a lead, there is a stronger relationship tie to the behavior of this sales representative to a customer prospect versus a sales representative that has registered a lead, but shows no direct interaction patterns, shows a lower probability pattern of customer connectedness in comparison to the earlier example. Real-time interaction patterns across a disparate set of sources can provide users with insights that prior art CRM systems do not provide, or alternatively to the extent that CRM systems or related applications include sales quota planning functionality, their accuracy has been less than optimal.

### Example In Operation

### Definitions

“Fact” f is a single abstract data point related to Industry, Customer, Opportunity, Sales Representative, Processes and Activities (as defined below).

Examples of facts:
Boolean example “repeatCustomer=true”
Date example “lastPhoneCall=2-Aug-2013”
Date example “salesRepJoinedDate=1-Sep-2008”
Location example: “demonstrationPerformedAt=Client office”
Number example “projectedSaleVolume=$3,500”
Enum example “industry=Telecommunications”
Enum example “state=Lead” “Industry” may include a representation of the Industry using a collection of facts.

Industry: i={f₁, . . . , fₙ}

“Customer” may include a representation of the buyer or client using a collection of facts.

Customer: c={f₁, . . . , fₙ}

“Sales representation” may include a representation of an existing (completed or potential) sales transaction expressed as a collection of facts. These facts represent any attributes relevant to the sales opportunity, such as “state=Lead”, “projectedSaleVolume=$3,500”, etc.

Opportunity: o={f₁, . . . , fₙ}

“Sales representative” may include a representation of the Sales Person using a collection of facts.

SalesPerson: r={f₁, . . . , fₙ}

“Sales action” may include a representation of a single action taken by a Sales Representative, there are different action types, for example phone call with customer, meeting with customer, send proposal, etc. . . . An action has associated attributes such as type, date, location, etc. . . .

Action: a=[a₁, a₂, . . . , aₙ]

“Sales process” may include a representation of a sales process as a tuple of sales representative, a series of actions and additional facts:

SalesProcess: sp=[i, c, o, r, (a₁, a₂, a₃, . . . , aₙ)]

Sales Insights

Sales insights generated by the computer system may include for example metrics that estimate specific quality of Sales Opportunity or Sales Process that are calculated using facts. Advanced algorithms and mathematical modeling may be used to calculate Sales Insights.

Some of the data types used to generate sales insights may include:
Date data, e.g. expected closing date: converted to a duration since a given key date (e.g. since question was answered, or since the opportunity was created, or since a key meeting was had)
Comparable data: for example, individual names. Again, actual names don't matter, but relations between names do matter, for example: is the influencer the same as the decision maker? among the influencers, how many attended this meeting?
Countable data: e.g. list of people in a meeting, # of attachments sent to a prospect, only concerned about the cardinality.
Multiple choice data, e.g. list of n challenges: converted to a list of booleans (one boolean per possible choice) resulting in n variables having 2 choices each, rather than one variable with 2̂n choices.
Numeric data (e.g. expected value of the opportunity) is marked as such, and left alone so the technology can learn numeric rules (e.g. deal values <1000 are more likely to close than deal values >1000, in certain conditions).
Location data, e.g. Where a meeting was held, location the initial contact was done. In this case the relationships between location data and known locations are stored (e.g. Selling company headquarters, client headquarter, third party location).
Symbolic (string) data (e.g. the industry for an opportunity) is marked as such, and left alone so the technology can analyze that, for example, industry “A” produces more closings than industry “B” in certain conditions.
Natural language text (e.g. emails between reps and prospects). The sentiment/language used in a string of a text can provide relationship insights in terms of using more positive language vs key words like: I have no interest, do not contact me, remove me from your mailing list etc, or a happy face.

Facts are gathered from source data according to the source data type (as above) and form (mostly DB tables or text content):
Each data source among all the data considered by the process may be annotated by type (date, multiple choice, comparable [e.g. for names], symbolic, numeric, countable, location)
   Comparable or location data care can be given a comparison reference, which is another data source of the same type (e.g. name of decision maker for a list of participants in a meeting; address of client company for meeting location)
   Date data sources can also be given a reference date, which is another date data source (e.g. opportunity creation date is the reference date for the expected closing date of the opportunity).
For each data type/source/reference data, a procedure may be provided to generate the relevant facts; for example to count how many days occurred between the first meeting date (the source data) and the opportunity creation date (the reference data for this source); or to determine whether the participants at a meeting (comparable data) included the decision maker (the reference data for this source).
Calculated facts may be stored in a fact table, each row in the table representing all the facts known about a sales process.
Each time new data becomes available about a sales process (usually when the process passes a new stage in the CRM software), the procedures may be triggered and new facts may be added to the relevant process.

Fact rows (FIG. 7, component 4) become the source of relevant knowledge gathered about each sales process, that will be used in the subsequent machine learning stages.

The insight engine (FIG. 7, component 5) is created using a database of past sales processes, some of which closed, some of which failed. The method consists of creating an insight engine consisting of a set of sets (aka a hierarchical ensemble) of classifiers (one classifier set per CRM sale stage) as described in FIG. 8. For each sale stage defined in the CRM workflow (called hereafter the “current stage”):
Facts can be gathered (using the approach described above in stages A and B) about each sale process that is, or has been, in the current stage. The facts can consist of the information collected at step A and processed at step B, and the knowledge of whether or not the sale will eventually close or not.
Facts can include all the knowledge gained about the sales process in all the stages the process has been through before, as well as knowledge gained on the process in the current stage. This set of data for each process in the given stage is called the “training data”.
Based on this training data, a set of classifiers can be trained for each sale stage, using supervised learning techniques. Supervised learning techniques consist of algorithms that learn to classify data into categories (for us, the categories may be “sale will close”/“sale will not close”) based on existing training data that has already been classified.
Each classifier can be trained on a random subset of the training data (for example 80% of the training data), so that each classifier learns slightly different knowledge. A possible embodiment of the invention is to use decision trees. Bayesian network or rule induction systems are other possible embodiments.
Each classifier can learn rules on what makes an opportunity ultimately successful or not. For example: if an opportunity has an expected closing date less than 1 month in the future, and the contract length is less than a year, it is 78% likely to close.

The rules learned by the insight engine can be used, in one implementation, in two different ways:

(1) to help the sales manager calculate the probability of each sale closing:
Each time an opportunity reaches a new stage, the known facts for that opportunity are calculated, in the same manner as before with the calculated facts from past opportunities used in the training set.
The known facts are then run through each classifier in the set trained for the latest stage of that opportunity. Each classifier will vote whether the opportunity will close or not (not all the classifiers in the set will have the same vote, because each has been trained on a slightly different data set).
To calculate the probability of the sale closing, a calculation may be performed to calculate the percentage of classifiers that have classified the new opportunity as “will close”; more agreement between classifiers implies more certainty that the sale will close.

Each time an opportunity goes through a new stage, the sales dashboard is updated as described in the following section to reflect the new probability of closing for that sale. Sales closing probabilities can be combined with deal size expectations (often entered in the CRM too) for each sale to provide a better picture of expected revenue.

(2) to help the sales reps close more opportunities. Each time more information is gathered about an opportunity, all the rules that might apply with the current facts and some yet unknown facts are compiled, and the desirable facts that would produce the most likely probability of closing are presented to the sales representative. For example if the representative has just entered an expected closing date within 30 days, the system will inform him that a short time contract is the most likely to close. Or, if a sales representative's customer's company has just lost millions of revenue and external forces are at work, the ranking of the sales reps opportunity due to external real time risk analytic intelligence would automatically rank lower the opportunity and in extreme cases, mark as 0 probability to close some sales in the next 12 months.

Natural Language Processing

Some of the input data from the sales process may be in natural language (e.g. plain English or French); for example meeting notes, “next steps” notes, emails between reps and prospects, etc. While these kinds of data contain useful information about the sale, it is not immediately exploitable by rule induction algorithms. A process has been developed to modify the natural language data in ways that can be used by a rule induction algorithm. The process consists of using another type of classification algorithm (in our case, a Naive Bayes Classifier), that is appropriate for natural language classification, and use the result of the classification as a feature of the training and testing data consumed by the rule induction algorithm described above. In essence, the natural language classifier analyses the sentiment in the natural language inputs; this sentiment is then used as a characteristic in the more general sales process.

SalesChoice's analytics will increasingly help to discern real patterns and anticipate events before they sometimes even happen.

Bayesian Networks

Bayesian Networks is another approach used for analyzing sales data and deriving insights. In this approach facts about the sales process and possible sales related actions are modelled as nodes in a directed acyclic graph and the edges represent the conditional fact-fact and fact-action dependencies.

The Bayesian techniques are used for inferring unobserved facts or actions:

Given a Bayesian network representation of facts and actions and new evidence (observed facts and/or actions) the posterior distribution of variables may be computed in the Bayesian network. The calculation may be refreshed to calculate how evidence about certain facts and actions affect the probabilities of other interesting variables contributing to the computation of the SalesRank function.

In some cases, the relevant Bayesian network is modelled by an expert in the field, who defines the initial relationships and probabilities between facts and actions. The inference process then kicks in and updates the probability given new evidence as described above. Bayesian Network Structure Learning techniques are used to automatically learn the graph structure of the Bayesian network.

Algebraic Topology

Algebraic topology is another method used in conjunction with other algorithms and processes. In this case, the facts derived from the external data sources are used to try to find algebraic invariants that classify topological spaces with the intent to describe several homotopy equivalences. The ideal case is to find a topological space (or spaces) that describes the Sales Process formula for patterns of success. Then for each sales representative, a topological space is derived and it is determined whether there is a homotopy equivalence. The presence of a homotopy equivalence indicates that the Sales Process followed by the sales representative follows a pattern of success (or not). This insight is then used in the set of outcomes from the insight engine.

Outcomes

Insights and facts may be aggregated into Outcomes that can be generic and specific. Outcomes (FIG. 7, component 7) are generic in the way they are organized, packaged and delivered. This way FIG. 7 they can be consumed by any other type of computing solution and by any other platform. Outcomes may be specific as they represent the final result of very unique, complex and highly advanced computational algorithms that process multiple data streams.

The computer system may generate, in one implementation, four categories of Outcomes.

1—Ranks (FIG. 7, component 8)

Ranks are typically calculated as aggregated Insights. Their goal is to provide a very high-level and easy to understand estimate of how good the sales process is.

Sales Rank

A result of function producing qualitative assessment for a given Sales Opportunity or Sales Process. A higher rank means the Sales Opportunity or Sales Process is more likely to materialize (e.g. equal to probability of closing)

SalesRank: SRank(sp)->[0,1]

Sales Representative Rank

A result of function producing a rank for a given Sales Person. A higher rank means the Sales Person is more likely to close sales opportunities and reach sales quota.

SalesREPRank: SRepRank(r)->[0,1]

2—Sales Alerts (FIG. 7., component 9)

Notifications that may have immediate and substantial impact on Sales Process of a particular opportunity. The lifespan of alerts is typically short (a few minutes to a few hours) therefore they are intended for quick consumption. An alert notification is generated when the system detects Alert-Triggering Event (in short: a Trigger), such as fact change or detection of arrival of a specific fact.

Examples of Alerts:
meet the customer in nearby coffee shop
make a phone call as soon as possible
the exchange rate for currency X has changed +3%

3—Sales Hints (FIG. 7, component 10)

Observations and conclusions provided to Sales Representatives and aimed directly to help improving sales results. Hints are formulated as an output of 3 activities:

(1) comparing Sales Representative's actions to actions of best or better performing Sales Representative

(2) comparing Sales Representative's actions to best patterns and practices stored in Sales Wisdom Base

(3) analyzing opportunities with lower Sales Rank

Examples of hints:

(h1) You have not met with customer X for 6 months. This is a very big buyer of our services (1.5 m a year). Consider a face-to-face meeting.

(h2) This opportunity is for a large amount but has a low Sales Rank and is in danger of not being closed. Consider calling for a bigger meeting with the customer.

Sales Hints may have a longer lifespan than Sales Alerts.

Sales Wisdom Base may be implemented as a knowledge base module gathering and aggregating past sales hints which actively helps Sales Representatives in keeping up with best practices and sales techniques.

4—Sales Indicators (FIG. 7, component 11)

Indicators may be generated using statistical and predictive analytics. Their objective is to inform about the current situation and deliver approximate answers to what is coming down during the sales quarter. Sales Indicators are typically used in the Sales Dashboard although, the indicators provided by SalesGPS are enriched with predictions and qualitative evaluation of sales opportunities and sales process.

There are 2 groups of Sales Indicators (SI):

(1) SI for Sales Representatives

(2) SI for Sales Directors

Group (1) allows Sales Representatives understand their current situation, e.g. What is their expected revenue generation at this point in time?

Group (2) provided upper-level management with knowledge on the state of each sales representative, and in aggregation on the overall state of the sales funnel, e.g. What is the expected overall revenue at this point in time?

Result Interface

The primary consumers of Outcomes are all kinds of realizations of Graphical User Interfaces. Outcomes can also be used as input stream for further aggregation and other types of processing.

Outcomes are provided to external world through several result delivery methods and points of interactions, collectively known as the Result Interface. The Result Interface is designed to facilitate distributed, asynchronous and multi-user computing platforms. In particular, the Result Interface is to provide to, and, take advantage of Cloud Computing. Messaging queues, subscription-based data feeds, distributed storage and many more technologies are employed to accomplish this objective.

Applications

The present invention may be implemented by providing a variety of different applications, which may be implemented as desktop applications, mobile applications, tablet applications, or any other type of application.

Applications for Sales Representative

In one possible implementation, the computer system of the present invention may be implemented by providing one or more applications for use by a sales representative. The application may enable:
Ordering sales processes based on probability of close
Evaluation of how an additional action affects the SalesRank, e.g. current sales process state is sp=[i, c, o, r, (a₁, a₂, a₃, . . . , aₙ)] and potential sales process state is sp′=[i, c, o, r, (a₁, a₂, a₃, . . . , aₙ, aₙ₊₁)]. This leads to the application of hinting which action should be taken as to maximize the SalesRank.
Evaluation of how an additional fact (e.g. industry change, new competitor) affects the SalesRank. This leads to the application of alerts and hints to the Sales Representative.

Applications for Sales Manager

In another possible implementation, the computer system of the present invention may be implemented by providing one or more applications for use by a sales manager. The application may enable:
Comparison of Sales Reps—sum all SalesRanks for a given Sales Representative to get a total rank by Sales Representative
Improvement of business planning by gaining more insight on the percentage of current opportunities that are likely to close, and by using expected deal size, the anticipated revenue.

The present invention may enable evaluation of the circumstances (industry type, contract length, meeting type . . . ) in which each sales representative performs best. The present invention therefore may also provide an intelligent sales representative evaluation tool.

Cloud Computing Generally

“Cloud computing” includes Internet based computing where shared resources, software and data are provided on demand. A “cloud” therefore can refer to a collection of resources (e.g., hardware, data and/or software) provided and maintained by an off-site party (e.g. third party), wherein the collection of resources can be accessed by an identified user over a network. The resources can include data storage services, word processing services, and many other general purpose computation (e.g., execution of arbitrary code) and information technological services that are conventionally associated with personal computers or local servers.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

In general, the concepts of “virtual” and “cloud computing” include the utilization of a set of shared computing resources (e.g. servers) which are typically consolidated in one or more data center locations. For example, cloud computing systems may be implemented as a web service that enables a user to launch and manage computing resources (e.g., virtual server instances) in third party data centers. In a cloud environment, computer resources may be available in different sizes and configurations so that different resource types can be specified to meet specific needs of different users. For example, one user may desire to use small instance as a web server and another larger instance as a database server, or an even larger instance for processor intensive applications. Cloud computing offers this type of outsourced flexibility without having to manage the purchase and operation of additional hardware resources within an organization.

A cloud-based computing resource is thought to execute or reside somewhere on the “cloud”, which may be an internal corporate network or the public Internet. From the perspective of an application developer or information technology administrator, cloud computing enables the development and deployment of applications that exhibit scalability (e.g., increase or decrease resource utilization as needed), performance (e.g., execute efficiently and fast), and reliability (e.g., never, or at least rarely, fail), all without any regard for the nature or location of the underlying infrastructure.

A number of factors have given rise to an increase in the utilization of cloud computing resources. For example, advances in networking technologies have significantly improved resource connectivity while decreasing connectivity costs. Advances in virtualization technologies have increased the efficiency of computing hardware by improving scalability and making it possible to more closely match computing hardware resources to the requirements of a particular computing task. Additionally, virtualization technologies commonly deployed in cloud computing environments have improved application reliability by enabling failover policies and procedures that reduce disruption due to an application or hardware failure.

Computing Environment

The description above discloses at a high level the various functions of the proposed control/management solution for a plurality of devices at the location.

In order to provide additional context for various aspects of the subject innovation, FIG. 7 and the following discussion are intended to provide a brief, general description of a suitable computing environment in which the various aspects of the present invention can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer (such as the computer(s) illustrated in the architecture described above) typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system of the present invention represents a collection of hardware and software elements that enable a user to manage a variety of device and information objects associated or generated by these devices, leveraging in-the-cloud resources in a new way.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It should be understood that the present invention may be extended by linking the invention with other technologies or processes useful in the monitoring, control or management of a variety of devices, for a variety of purposes.

We claim:

1. A computer network implemented system is provided comprising:
one or more server computers, linked to a web application or application repository, or to a cloud service, providing:
(a) a workflow designer that is operable to enable the design of one or more workflows that utilize information or functions from one or more (i) business systems, (ii) applications, or (iii) databases; and
(b) an application programming interface (API) that is configured to connect to the (i) business systems, (ii) applications or (iii) databases so as to monitor user actions, and based on such user interactions applying one or more workflow overlays that incorporate one or more intelligent features for enhancing functions of the business systems and the applications.

2. A system comprising:
at least one client computing device; and
at least one computer server in communication with the at least one computing device over a communications network;
the at least one client computing device configured to:
receive one or more sales process parameters;
analyze information elements from one or more data sources or data stores, based on the sales process parameters so as to generate one or more insights relevant to performance of a sales representative relative to one or more sales objectives; and
presenting the insights to a sales representative to guide one or more actions of the sales representative.

3. The system of claim 1, wherein the insights are generated by an insight engine that implement one or more data analysis operations.

4. The system of claim 2, wherein the insight engine executes one or more sales forecasting operations.
